(19) United States
(12) Patent Application Publication
(10) Pub. No.: US 2026/0259663 A1
(43) Pub. Date: Sep. 3, 2026

(54) FACILITATING PERFORMANCE OF NODE-LEVEL DISAGGREGATED STORAGE SYSTEM WORKFLOWS BASED ON INFORMATION RELATING TO UNITS OF STORAGE SPACE FOR MOVEMENT AND OWNERSHIP

(71) Applicant: NetApp, Inc., San Jose, CA (US)

(72) Inventors: Yash Hetal Trivedi, San Jose, CA (US); Matthew Curtis-Maury, Apex, NC (US); Sushilkumar Gangadharan, San Jose, CA (US); William Arthur Gutknecht, Greensboro, NC (US); Mrinal K. Bhattarcharjee, Bangalore (IN); Jian Hu, Apex, NC (US); Sumith Makam, Bangalore (IN)

(73) Assignee: NetApp, Inc., San Jose, CA (US)

(21) Appl. No.: 19/184,108

(22) Filed: Apr. 21, 2025

(30) Foreign Application Priority Data
Mar. 5, 2025 (IN) 202541019589

(51) Int. Cl. G06F 3/06

(52) U.S. Cl. CPC G06F 3/0608; G06F 3/0631; G06F 3/067

(57) ABSTRACT

Systems and methods for use of information relating to units of storage space movement and ownership to facilitate performance of disaggregated storage system workflows are provided. In various examples, the unit of disaggregated storage space for purposes of movement and ownership is an allocation area (AA). AA ownership information relating to AAs owned by dynamically extensible file systems (DEFSs) of a cluster may be maintained within two different persistent data sources, including an AA label region and DEFS AA owner metafiles. A node-scoped cache may be implemented to cache the AA ownership information in-memory for DEFSs hosted by a given node to provide a multiprocessing (MP)-safe cache for AA ownership information, a mechanism to coordinate between AA movement and other subsystems needing to know whether an AA is “local” or “remote,” and a mechanism to serialize access and Input/Output (IO) operations to the persistent AA ownership information data sources.

### CROSS-REFERENCE TO RELATED APPLICATIONS

This application claims the benefit of priority of IN Provisional Application No. 202541019589, filed on Mar. 3, 2025, which is hereby incorporated by reference in its entirety for all purposes.

### BACKGROUND

### Field

Various embodiments of the present disclosure generally relate to storage systems. In particular, some embodiments relate to mechanisms for tracking ownership of and managing access to units of storage (e.g., allocation areas (AAs)) into which a storage space of a storage pod of a distributed storage system has been partitioned and assigned to dynamically extensible file systems (DEFSs) of the distributed storage system) as the units of storage are moved among the DEFS, for example, as part of space balancing operations.

### Description of the Related Art

Some prior scale-out storage solutions tightly couple compute and storage infrastructure. For example, as shown in FIG. 5, each node of a distributed storage system may be associated with a dedicated pool of storage space (e.g., a node-level aggregate representing a file system that holds one or more volumes created over one or more RAID groups and which is only accessible from a single node at a time). In such an environment, workflows (e.g., freeing of unused blocks, RAID reconstruction, and file system consistency checking) can be performed independently on individual nodes of a cluster representing the distributed storage system and need not interact or coordinate with each other.

### SUMMARY

Systems and methods are described for use of information relating to units of storage space movement and ownership to facilitate performance of disaggregated storage system workflows. According to one embodiment, a distributed storage system maintains an in-memory cache of allocation area (AA) ownership information on each node of multiple nodes of a cluster representing the distributed storage system in which the AA ownership information relates to a respective set of one or more dynamically extensible file systems (DEFSs) of multiple DEFSs of the distributed storage system that are resident on the node. For each AA of multiple AAs, a node-level disaggregated workflow operable on a first node selectively performs processing relating to the AA requested by a cluster-wide workflow based on the in-memory AA ownership cache on the first node indicating the AA is owned by one of the respective set of one or more DEFSs resident on the first node.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating a plurality of nodes interconnected as a cluster in accordance with an embodiment of the present disclosure.

FIG. 2 is a block diagram illustrating a node in accordance with an embodiment of the present disclosure.

FIG. 3 is a block diagram illustrating a storage operating system in accordance with an embodiment of the present disclosure.

FIG. 4 is a block diagram illustrating a tree of blocks representing of an example a file system layout in accordance with an embodiment of the present disclosure.

FIG. 5 is a block diagram illustrating a distributed storage system architecture in which the entirety of a given disk and a given RAID group are owned by an aggregate and the aggregate file system is only visible from one node, thereby resulting in silos of storage space.

FIG. 6A is a block diagram illustrating a distributed storage system architecture that provides disaggregated storage in accordance with an embodiment of the present disclosure.

FIG. 6B is a high-level flow diagram illustrating operations for establishing disaggregated storage within a storage pod in accordance with an embodiment of the present disclosure.

FIG. 7 is a block diagram conceptually illustrating an example of disaggregated storage system workflows involving a source DEFS and a destination DEFS in accordance with an embodiment of the present disclosure.

FIG. 8 is a block diagram conceptually illustrating another example of disaggregated storage system workflows involving a source DEFS and a destination DEFS in accordance with an embodiment of the present disclosure.

FIG. 9 is a block diagram conceptually illustrating an example of sibling or corresponding disaggregated storage system workflows triggered by a cluster-wide workflow in accordance with an embodiment of the present disclosure.

FIG. 10 is a block diagram conceptually illustrating nodes of a cluster and AA ownership information in accordance with an embodiment of the present disclosure.

FIG. 11 is a block diagram conceptually illustrating a global ownership of AAs table (GOAT) in accordance with an embodiment of the present disclosure.

FIG. 12 is a high-level flow diagram illustrating operations for performing a disaggregated workflow associated with a DEFS in accordance with an embodiment of the present disclosure.

FIG. 13 is a high-level flow diagram illustrating operations for performing donor-recipient disaggregated workflows in accordance with an embodiment of the present disclosure.

FIG. 14 is a high-level flow diagram illustrating operations for performing a cluster-wide workflow involving multiple node-level disaggregated workflows in accordance with an embodiment of the present disclosure.

FIG. 15 is a high-level flow diagram illustrating operations for performing a cluster-wide workflow involving multiple DEFS-level disaggregated workflows in accordance with an embodiment of the present disclosure.

### DETAILED DESCRIPTION

Systems and methods are described for use of information relating to units of storage space movement and ownership to facilitate performance of disaggregated storage system workflows. As noted above, some prior scale-out storage solutions tightly couple compute and storage infrastructure, for example, by associating each node of a cluster representing the storage solution with its own dedicated pool of storage space (e.g., a node-level aggregate (a set of storage devices) representing a file system that holds one or more volumes created over one or more RAID groups and which is only accessible from a single node at a time). As will be appreciated based on the description below, in such an environment, there was no need for tracking ownership of units of a disaggregated storage space that may be statically assigned and/or dynamically moved among such node-level aggregates. In such prior storage solutions, various common workflows (e.g., block free and reference count increment) associated with storage of data on behalf of clients involve only the node-level aggregate at issue. Additionally, even cluster-wide workflows (e.g., file system consistency checking and RAID reconstruction) are capable of being performed in such an environment independently by the respective node-level aggregates of the individual nodes of the cluster without requiring synchronization or coordination among the nodes.

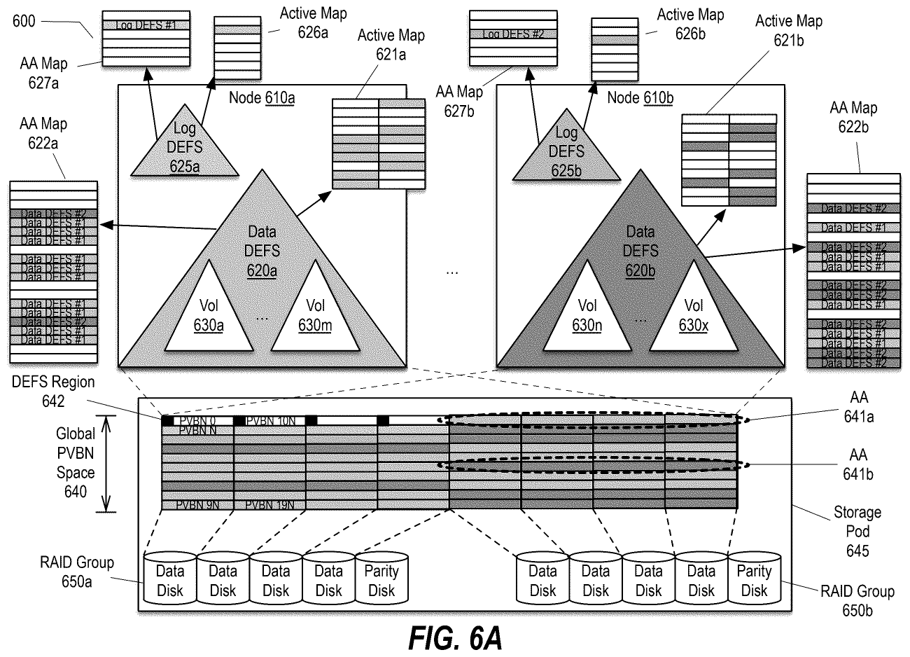

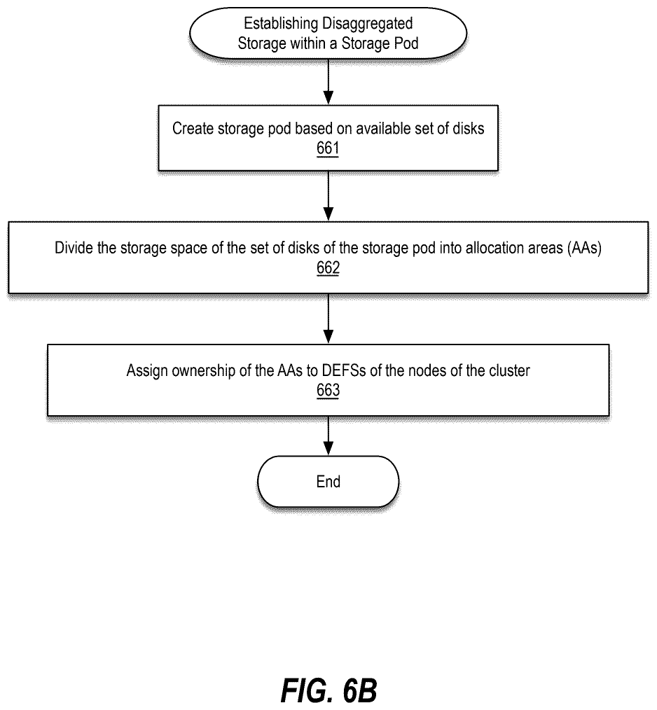

When moving to a scale-out storage solution architecture that makes use of disaggregated storage in which storage space may be used more fluidly across all the individual storage systems (e.g., nodes) of a distributed storage system (e.g., a cluster of nodes working together), for example, as described with reference to FIG. 6A in which “dynamically extensible file systems” (DEFSs) are used, performance and/or coordination of workflows (which may be referred to as disaggregated storage system workflows or simply disaggregated workflows) becomes more complex. For example, the ability to perform various operations (e.g., writing to blocks, accessing metadata information associated with such blocks, and/or accessing metadata information associated with the unit of disaggregated storage space with which such blocks are associated) should be limited to the DEFS of the cluster that owns the unit of disaggregated storage space with which the data block at issue is associated. Additionally, as described further below, new workflows may be introduced in a disaggregated storage environment, including, for example, the ability to dynamically move units of the disaggregated storage space within the cluster. This creates a need for data structures and mechanisms for tracking and accessing information (e.g., Allocation Area (AA) ownership information and AA state information) relating to the units of the disaggregated storage space (e.g., AAs) to facilitate performance of disaggregated workflows. In some examples, the association of blocks to a dynamically extensible file system may be in large chunks of one or more gigabytes (GB), which are referred to herein as “allocation areas” (AAs) that each include multiple RAID stripes. In addition, these AAs (and associated metadata information, for example, in the form of metafiles or portions thereof) may be moved from one dynamically extensible file system (DEFS) to another on the same or a different node of the cluster to facilitate space balancing, for example, by making use of new workflows (e.g., an AA movement workflow). As a result of the distribution of ownership of AAs of the common storage pod among DEFSs of a cluster and the ability to dynamically move the AAs from one DEFS to another, there arises a need to track state information and ownership of the AAs within a cluster. Various previous workflows that involved only a single node-level aggregate or could be independently performed by multiple node-level aggregates now, in a disaggregated storage environment, involve multiple DEFSs (e.g., a source and destination DEFS, which may also be referred to as local and remote DEFSs or donor and recipient DEFSs, depending on the context) or involve synchronization or coordination among the disaggregated storage system workflows. Additionally, the complexity of these disaggregated storage system workflows has increased given they should consult AA ownership information before taking action with respect to a block or associated metadata information. In some cases, a disaggregated workflow operating on a local DEFS may need to request modification of metadata information associated with a block by a remote DEFS on its behalf. As in various embodiments described herein, an AA is both the unit of storage space movement and the unit of ownership of all physical volume block numbers (PVBNs) associated therewith, this need may arise, for example, in a scenario in which an AA with which the block is associated was moved to (or had its ownership changed to) the remote DEFS after the block had been write allocated by the local DEFS. In other cases, sub-workflows (e.g., disaggregated workflows associated with individual DEFS of the cluster) may be triggered by a cluster-wide workflow (e.g., file system consistency checking and RAID reconstruction) and may involve a need for synchronization and/or coordination among such sub-workflows.

Embodiments described herein introduce various mechanisms for tracking and making available AA ownership information and AA state information to facilitate performance of disaggregated workflows. For example, as described further below, AA ownership information relating to the AAs assigned to/owned by DEFSs of a cluster may be maintained within two different on-disk data sources, including an AA label region and DEFS AA owner metafiles, which may be used for different purposes and have different scopes (e.g., DEFS AA owner metafiles may be DEFS scoped and the AA label region may be cluster scoped). Additionally, a node-scoped cache, which may be referred to as a global ownership of AAs table or GOAT, may be implemented to cache the AA ownership information in-memory for all DEFSs hosted by (or resident on) a given node, so as to provide, among other things, a multiprocessing (MP)-safe cache for AA ownership information, a mechanism to coordinate between AA movement and other subsystems that need to know whether an AA is “local” or “remote” (e.g., owned by a given DEFS or another DEFS within the cluster), and a mechanism to serialize access and Input/Output (IO) operations to the on-disk AA ownership information data sources.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

The terms “component”, “module”, “system,” and the like as used herein are intended to refer to a computer-related entity, either software-executing general-purpose processor, hardware, firmware and a combination thereof. For example, a component may be, but is not limited to being, a process running on a hardware processor, a hardware processor, an object, an executable, a thread of execution, a program, and/or a computer. By way of illustration, both an application running on a server and the server can be a component. One or more components may reside within a process and/or thread of execution, and a component may be localized on one computer and/or distributed between two or more computers. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The term file/files as used herein include data container/data containers, directory/directories, and/or data object/data objects with structured or unstructured data. Some files may be used to store client data and other files (e.g., metafiles) may be used to store metadata used by the storage operating system or a DEFS (e.g., a space map indicative of which PVBNs within a storage pod are in use or an active map indicative of which PVBNs of AAs owned by a given DEFS are in use).

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider or hyperscaler (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, a “storage system” or “storage appliance” generally refers to a type of computing appliance or node, in virtual or physical form, that provides data to, or manages data for, other computing devices or clients (e.g., applications). The storage system may be part of a cluster of multiple nodes representing a distributed storage system. In various examples described herein, a storage system may be run (e.g., on a VM or as a containerized instance, as the case may be) within a public cloud provider.

As used herein, the term “storage operating system” generally refers to computer-executable code operable on a computer to perform a storage function that manages data access and may, in the case of a storage system (e.g., a node), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein. In some embodiments, a light-weight data adaptor may be deployed on one or more server or compute nodes added to a cluster to allow compute-intensive data services to be performed without adversely impacting performance of storage operations being performed by other nodes of the cluster. The light-weight data adaptor may be created based on a storage operating system but, since the server node will not participate in handling storage operations on behalf of clients, the light-weight data adaptor may exclude various subsystems/modules that are used solely for serving storage requests and that are unnecessary for performance of data services. In this manner, compute intensive data services may be handled within the cluster by one of more dedicated compute nodes.

As used herein, a “cloud volume” generally refers to persistent storage that is accessible to a virtual storage system by virtue of the persistent storage being associated with a compute instance in which the virtual storage system is running. A cloud volume may represent a hard-disk drive (HDD) or a solid-state drive (SSD) from a pool of storage devices (or “disks” which is used interchangeably throughout this specification) within a cloud environment that is connected to the compute instance through Ethernet or fibre channel (FC) switches as is the case for network-attached storage (NAS) or a storage area network (SAN). Non-limiting examples of cloud volumes include various types of SSD volumes (e.g., AWS Elastic Block Store (EBS) gp2, gp3, io1, and io2 volumes for EC2 instances) and various types of HDD volumes (e.g., AWS EBS st1 and sc1 volumes for EC2 instances).

As used herein a “consistency point” or “CP” generally refers to the act of writing data to disk and updating active file system pointers. In various examples, when a file system of a storage system receives a write request, it commits the data to permanent storage before the request is confirmed to the writer. Otherwise, if the storage system were to experience a failure with data only in volatile memory, that data would be lost, and underlying file structures could become corrupted. Physical storage appliances commonly use battery-backed high-speed non-volatile random access memory (NVRAM) as a journaling storage media to journal writes and accelerate write performance while providing permanence, because writing to memory is much faster than writing to storage (e.g., disk). Storage systems may also implement a buffer cache in the form of an in-memory cache to cache data that is read from data storage media (e.g., local mass storage devices or a storage array associated with the storage system) as well as data modified by write requests. In this manner, in the event a subsequent access relates to data residing within the buffer cache, the data can be served from local, high performance, low latency storage, thereby improving overall performance of the storage system. Virtual storage appliances may use NV storage backed by cloud volumes in place of NVRAM for journaling storage and for the buffer cache. Regardless of whether NVRAM or NV storage is utilized, the modified data may be periodically (e.g., every few seconds) flushed to the data storage media. As the buffer cache may be limited in size, an additional cache level may be provided by a victim cache, typically implemented within a slower memory or storage device than utilized by the buffer cache, that stores data evicted from the buffer cache. The event of saving the modified data to the mass storage devices may be referred to as a CP. At a CP, the file system may save any data that was modified by write requests to persistent data storage media. As will be appreciated, when using a buffer cache, there is a small risk of a system failure occurring between CPs, causing the loss of data modified after the last CP. Consequently, the storage system may maintain an operation log or journal of certain storage operations within the journaling storage media that have been performed since the last CP. This log may include a separate journal entry (e.g., including an operation header) for each storage request received from a client that results in a modification to the file system or data. Such entries for a given file may include, for example, “Create File,” “Write File Data,” and the like. Depending upon the operating mode or configuration of the storage system, each journal entry may also include the data to be written according to the corresponding request. The journal may be used in the event of a failure to recover data that would otherwise be lost. For example, in the event of a failure, it may be possible to replay the journal to reconstruct the current state of stored data just prior to the failure. As described further below, in various examples there may be one or more predefined or configurable triggers (CP triggers). Responsive to a given CP trigger (or at a CP), the file system may save any data that was modified by write requests to persistent data storage media.

As used herein, a “consistency point count” or “CP count” generally refers to a count of the number of CPs that have been performed by a given DEFS. The CP count may be used to perform local timeline checks, but as noted above, may not be used to perform cluster-wide timeline checks due to the fact that the DEFSs of a cluster independently perform CPs and may do so at different rates.

As used herein, a “RAID stripe” generally refers to a set of blocks spread across multiple storage devices (e.g., disks of a disk array, disks of a disk shelf, or cloud volumes) to form a parity group (or RAID group). In examples described herein, a RAID stripe is the same set of disk block numbers (DBNs) across all the disks.

As used herein, an “allocation area” or “AA” generally refers to a group of RAID stripes. In various examples described herein a single storage pod may be shared by a distributed storage system by assigning ownership of AAs to respective dynamically extensible file systems of a storage system.

As used herein, “ownership” of an AA generally refers to the ability of the owning DEFS to use the AA space (e.g., the blocks associated with the AA) for performance of writes or write operations. In the context of various embodiments described herein, only one DEFS can write to a given block (PVBN) at a time for multiple correctness reasons, so it is the DEFS that owns the given AA of which the given block is associated that has the exclusive ability among all other DEFSs in the storage system to write to the given block. Further, in embodiments described herein, for the file system metadata to be correct, the file system metadata for a given AA and the PVBNs associated with the given AA is coordinated in one place. In various examples described herein, metadata information associated with a given AA and/or all PVBNs of the given AA may also be said to be owned by the DEFS that owns the AA (regardless of which AA may have “write allocated” a given PVBN).

As used herein, “space balancing” generally refers to the movement of one or more AAs from one DEFS (which may be referred to as a donor DEFS) to another DEFS (which may be referred to as a recipient DEFS) of a storage system; or stated another way changing of the ownership of one or more AA from the donor DEFS to the recipient DEFS. Space balancing may be performed to address a number of storage space-related issues including, but not limited to, balancing of (i) free space within DEFSs of a storage cluster, (ii) used space within the DEFSs, (iii) total owned space, and/or (iv) AA quality owned by the DEFSs.

As used herein, a “quality” of an AA generally refers to one of a multiple categories, buckets, bins, or enumerated types of AAs, for example, with respect to the level of usage of PVBNs associated with the AA. In one example, AAs may be categorized coarsely as (i) free AAs, (ii) partial AAs, and (iii) full AAs. In other examples, the partial AAs may be further refined by bucketing or binning the AAs in accordance with predetermined or configurable used space percentage ranges or bands (e.g., of 5 to 10 percent) based on their respective PVBNs that are in use.

As used herein, a “free allocation area” or “free AA” generally refers to an AA in which no PVBNs of the AA are marked as used, for example, by any active maps of a given dynamically extensible file system.

As used herein, a “partial allocation area” or “partial AA” generally refers to an AA in which one or more PVBNs of the AA are marked as in use (containing valid data), for example, by an active map of a given dynamically extensible file system. As discussed further below, in connection with space balancing, while it is preferable to perform AA ownership changes of free AAs, in various examples, space balancing may involve one dynamically extensible file system donating one or more partial AAs to another dynamically extensible file system. In such cases, the additional cost of copying portions of one or more associated data structures (e.g., bit maps, such as an active map, a refcount map, a summary map, an AA information map, and a space map) relating to storage space information may be incurred. No such additional cost is incurred when moving or changing ownership of free AAs. These associated data structures may, among other things, track which PVBNs are in use, track PVBN counts per AA (e.g., total used blocks and shared references to blocks) and other flags.

As used herein, a “storage pod” generally refers to a group of storage devices (e.g., disks) containing multiple RAID groups that are accessible from all storage systems (nodes) of a distributed storage system (cluster).

As used herein, a “data pod” generally refers to a set of storage systems (nodes) that share the same storage pod. In some examples, a data pod refers to a single cluster of nodes representing a distributed storage system. In other examples, there can be multiple data pods in a cluster. Data pods may be used to limit the fault domain and there can be multiple HA pairs of nodes within a data pod.

As used herein, an “active map” is a data structure that contains information indicative of which PVBNs of a distributed file system are in use. In one embodiment, the active map is represented in the form of a sparse bit map, for example, maintained within a metafile, in which each PVBN of a global PVBN space of a storage pod has a corresponding Boolean value (or truth value) represented as a single bit, for example, in which the true (1) indicates the corresponding PVBN is in use and false (0) indicates the corresponding PVBN is not in use.

As used herein, a “dynamically extensible file system” or a “DEFS” generally refers to a file system of a data pod or a cluster that has visibility into the entire global PVBN space of a storage pod and hosts multiple volumes. A DEFS may be thought of as a data container or a storage container (which may be referred to as a storage segment container) to which AAs are assigned, thereby resulting in a more flexible and enhanced version of a node-level aggregate. As described further herein (for example, in connection with automatic space balancing), the storage space associated with one or more AAs of a given DEFS may be dynamically transferred or moved on demand to any other DEFS in the cluster by changing the ownership of the one or more AAs and moving associated AA tracking data structures as appropriate. This provides the unique ability to independently scale each DEFS of a cluster. For example, DEFSs can shrink or grow dynamically over time to meet their respective storage needs and silos of storage space are avoided. In one embodiment, a distributed file system comprises multiple instances of the WAFL® Copy-on-Write file system running on respective storage systems (nodes) of a distributed storage system (cluster) that represents the data pod. In various examples described herein, a given storage system (node) of a distributed storage system (cluster) may own one or more DEFSs including, for example, a log DEFS for storing log files (e.g., for debugging) and a data DEFS for hosting customer volumes or logical unit numbers (LUNs). As described further below, the partitioning/division of a storage pod into AAs (creation of a disaggregated storage space) and the distribution of ownership of AAs among DEFSs of multiple nodes of a cluster may facilitate implementation of a distributed storage system having a disaggregated storage architecture. In various examples described herein, each storage system may have its own portion of disaggregated storage to which it has the exclusive ability to perform write access, thereby simplifying storage management by, among other things, not requiring implementation of access control mechanisms, for example, in the form of locks. At the same time, each storage system also has visibility into the entirety of a global PVBN space, thereby allowing read access by a given storage system to any portion of the disaggregated storage regardless of which node of the cluster is the current owner of the underlying allocation areas. Based disclosure provided herein, those skilled in the art will understand there are at least two types of disaggregation represented/achieved within various examples, including (i) the disaggregation of storage space provided by a storage pod by dividing or partitioning the storage space into AAs the ownership of which can be fluidly changed from one DEFS to another on demand and (ii) the disaggregation of the storage architecture into independent components, including the decoupling of processing resources and storage resources, thereby allowing them to be independently scaled. In one embodiment, the former (which may also be referred to as modular storage, partitioned storage, adaptable storage, or fluid storage) facilitates the latter.

As noted above, in some embodiments, AAs are the unit of storage space movement as well as the unit of ownership. In such embodiments, a given AA, all PVBNs within the given AA, metadata information associated with the given AA, and metadata information associated with the PVBNs within the given AA are all owned by the DEFS that owns the given AA. Therefore, in various examples described herein, a PVBN is considered to be “local” to a given DEFS when the PVBN is associated with an AA owned by the given DEFS regardless of the DEFS that may have previously owned the AA at a time at which the PVBN was write allocated. Similarly, a PVBN is considered to be “remote” with respect to a given DEFS when the PVBN is associated with an AA owned by a DEFS other than the given DEFS. In various examples described herein, prior to attempting to update metadata information (e.g., active map metafile and reference count (refcount) metafile) associated with a PVBN, for example, in connection with a block free (or PVBN refcount decrement) process, the workflow at issue associated with a given DEFS that has identified the need to update the metadata information consults the local GOAT cached on the node hosting the given DEFS to determine whether the PVBN (and the associated AA) is local or remote, which in turn dictates whether the block free and associated metadata information update can be performed locally via a local block free path or remotely via a remote block free path of a “remote” DEFS.

As used herein, a DEFS may be considered “remote” with respect to a given DEFS (a “local” DEFS) simply as a result of being a separate DEFS and regardless of whether the remote DEFS resides on the same node or a different node of the cluster as the given DEFS.

As used herein, a “donor DEFS” generally refers to a DEFS within a cluster from which ownership of a unit of storage (e.g., an AA) is to be transferred to another DEFS (referred to as the “recipient DEFS”) within the cluster.

As used herein, a “disaggregated storage system workflow” or simply a “disaggregated workflow” generally refers to a workflow in the context of a distributed storage system that makes use of disaggregated storage and which involves movement of one or more AAs, modification of one or more AAs (or one or more PVBNs thereof), and/or accessing or modifying metadata information (e.g., one or more metafiles or portions thereof associated with AAs or one or more metafiles or portions thereof of associated PVBNs). In some cases, multiple disaggregated workflows may interact or communicate with each other via their respective DEFSs. For example, a donor DEFS may donate or move one or more of its AAs to a recipient DEFS as part of an AA movement workflow, a local DEFS may request a remote DEFS to perform action (e.g., update metadata information associated with a remote PVBN) on behalf of a disaggregated workflow running on the local DEFS, or multiple sub-workflows (e.g., DEFS-level file system consistency check workflows or node-level RAID reconstruction workflows) triggered by a cluster-wide workflow (e.g., a cluster-level file system consistency check process or cluster-level a RAID reconstruction process) may synchronize or otherwise coordinate their activities.

As used herein, “AA ownership information” generally refers to information indicative of states of respective AAs of a storage pod of a cluster and DEFS AA owner metadata information (e.g., a DEFS AA owner metafile) for each DEFS of the cluster. In various examples described herein persistent AA ownership information may be maintained within two different on-disk data sources, including AA labels of an AA label region and DEFS AA owner metafiles, which may be used for different purposes and have different scopes.

As described further below, a distributed storage system may also maintain a copy of portions of the persistent AA ownership information in an in-memory cache (referred to herein as “a Global Ownership of AAs Table” or “GOAT”) on each node of the cluster in which the cached portion of AA ownership information within a particular GOAT entry corresponding to a given AA includes AA ownership information relating to the given AA and a portion of the DEFS AA ownership metadata information for those of the DEFSs resident on or hosted by the node at issue.

As used herein, an “AA label” generally refers to a data structure containing state information for a given AA of a storage pod of a cluster. In various examples described herein the state information in indicative of whether ownership of the given AA is in transition, identifies a DEFS that currently owns the given AA (when the ownership of the given AA is not in transition), and identifies a DEFS that is proposed to own the given AA (when the ownership of the given AA is in transition)

As used herein, an “allocation area map,” “AA map,” “AA bitmap,” “AA owner file,” “AA owner metafile,” “DEFS AA owner metafile” or the like generally refers to a per DEFS data structure or file (e.g., a metafile) that contains metadata information at an AA-level of granularity indicative of which AAs are assigned to or “owned” by a given DEFS.

A “node-level aggregate” generally refers to a file system of a single storage system (node) that holds multiple volumes created over one or more RAID groups, in which the node owns the entire PVBN space of the collection of disks of the one or more RAID groups. Node-level aggregates are only accessible from a single storage system (node) of a distributed storage system (cluster) at a time.

As used herein, an “inode” generally refers to a file data structure maintained by a file system that stores metadata for data containers (e.g., directories, subdirectories, disk files, etc.). An inode may include, among other things, location, file size, permissions needed to access a given file with which it is associated as well as creation, read, and write timestamps, and one or more flags.

As used herein, a “storage volume” or “volume” generally refers to a container in which applications, databases, and file systems store data. A volume is a logical component created for the host to access storage on a storage array. A volume may be created from the capacity available in storage pod, a pool, or a volume group. A volume has a defined capacity. Although a volume might consist of more than one drive, a volume appears as one logical component to the host. Non-limiting examples of a volume include a flexible volume and a flexgroup volume.

As used herein, a “flexible volume” generally refers to a type of storage volume that may be efficiently distributed across multiple storage devices. A flexible volume may be capable of being resized to meet changing business or application requirements. In some embodiments, a storage system may provide one or more aggregates and one or more storage volumes distributed across a plurality of nodes interconnected as a cluster. Each of the storage volumes may be configured to store data such as files and logical units. As such, in some embodiments, a flexible volume may be comprised within a storage aggregate and further comprises at least one storage device. The storage aggregate may be abstracted over a RAID plex where each plex comprises a RAID group. Moreover, each RAID group may comprise a plurality of storage disks. As such, a flexible volume may comprise data storage spread over multiple storage disks or devices. A flexible volume may be loosely coupled to its containing aggregate. A flexible volume can share its containing aggregate with other flexible volumes. Thus, a single aggregate can be the shared source of all the storage used by all the flexible volumes contained by that aggregate. A non-limiting example of a flexible volume is a NetApp ONTAP Flex Vol volume.

As used herein, a “flexgroup volume” generally refers to a single namespace that is made up of multiple constituent/member volumes. A non-limiting example of a flexgroup volume is a NetApp ONTAP FlexGroup volume that can be managed by storage administrators, and which acts like a NetApp Flex Vol volume. In the context of a flexgroup volume, “constituent volume” and “member volume” are interchangeable terms that refer to the underlying volumes (e.g., flexible volumes) that make up the flexgroup volume.

### Example Distributed Storage System Cluster

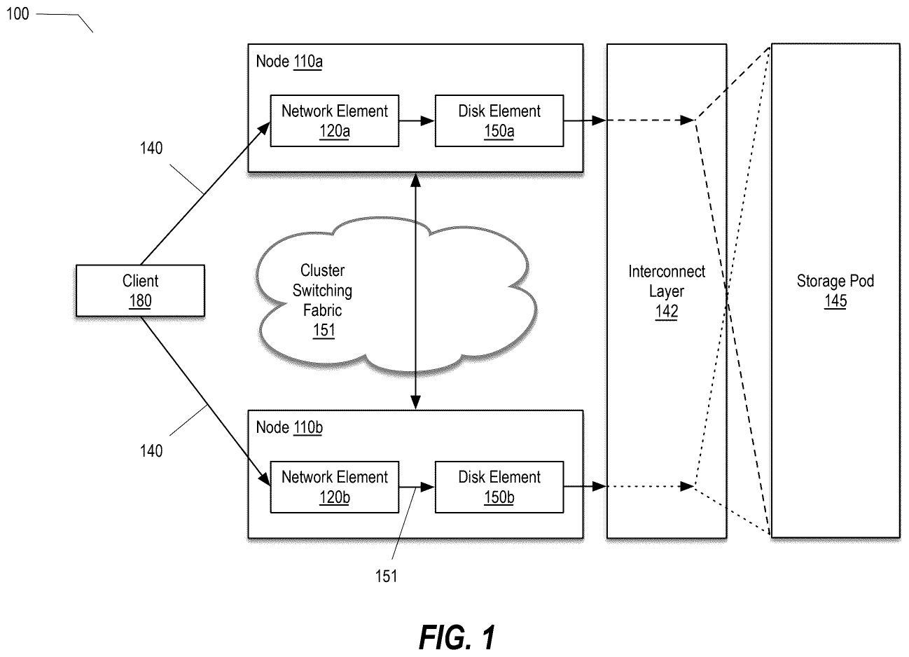

FIG. 1 is a block diagram illustrating a plurality of nodes 110a-b interconnected as a cluster 100 in accordance with an embodiment of the present disclosure. In the context of the present example, the nodes 110a-b comprise various functional components that cooperate to provide a distributed storage system architecture of the cluster 100. To that end, in the context of the present example, each node is generally organized as a network element (e.g., network element 120a or 120b) and a disk element (e.g., disk element 150a or 150b). The network element includes functionality that enables the node to connect to clients (e.g., client 180) over a computer network 140, while each disk element 350 connects to one or more storage devices, such as disks, of one or more disk arrays (not shown) or of one or more storage shelves (not shown), represented as a single shared storage pod 145.

In the context of the present example, the nodes 110a-b are interconnected by a cluster switching fabric 151 which, in an example, may be embodied as a Gigabit Ethernet switch. It should be noted that while there is shown an equal number of network and disk elements in the illustrative cluster 100, there may be differing numbers of network and/or disk elements. For example, there may be a plurality of network elements and/or disk elements interconnected in a cluster configuration 100 that does not reflect a one-to-one correspondence between the network and disk elements. As such, the description of a node comprising one network element and one disk element should be taken as illustrative only.

Clients may be general-purpose computers configured to interact with the node in accordance with a client/server model of information delivery. That is, each client (e.g., client 180) may request the services of the node, and the node may return the results of the services requested by the client, by exchanging packets over the network 140. The client may issue packets including file-based access protocols (e.g., the Common Internet File System (CIFS) protocol or Network File System (NFS) protocol), over the Transmission Control Protocol/Internet Protocol (TCP/IP) when accessing information in the form of files and directories. Alternatively, the client may issue packets including block-based access protocols, such as the Small Computer Systems Interface (SCSI) protocol encapsulated over TCP (iSCSI) and SCSI encapsulated over Fibre Channel (FCP), when accessing information in the form of blocks. In various examples described herein, an administrative user (not shown) of the client may make use of a user interface (UI) presented by the cluster or a command line interface (CLI) of the cluster to, among other things, establish a data protection relationship between a source volume and a destination volume (e.g., a mirroring relationship specifying one or more policies associated with creation, retention, and transfer of snapshots), defining snapshot and/or backup policies, and association of snapshot policies with snapshots.

Storage elements (e.g., disk elements 150a and 150b) are illustratively connected to storage devices (e.g., disks) (not shown) within that may be organized into storage (disk) arrays within the storage pod 145. Alternatively, storage devices other than disks may be utilized, e.g., flash memory, optical storage, solid state devices, etc. As such, the description of disks should be taken as exemplary only and references to disks herein should be understood to refer to storage devices more generally.

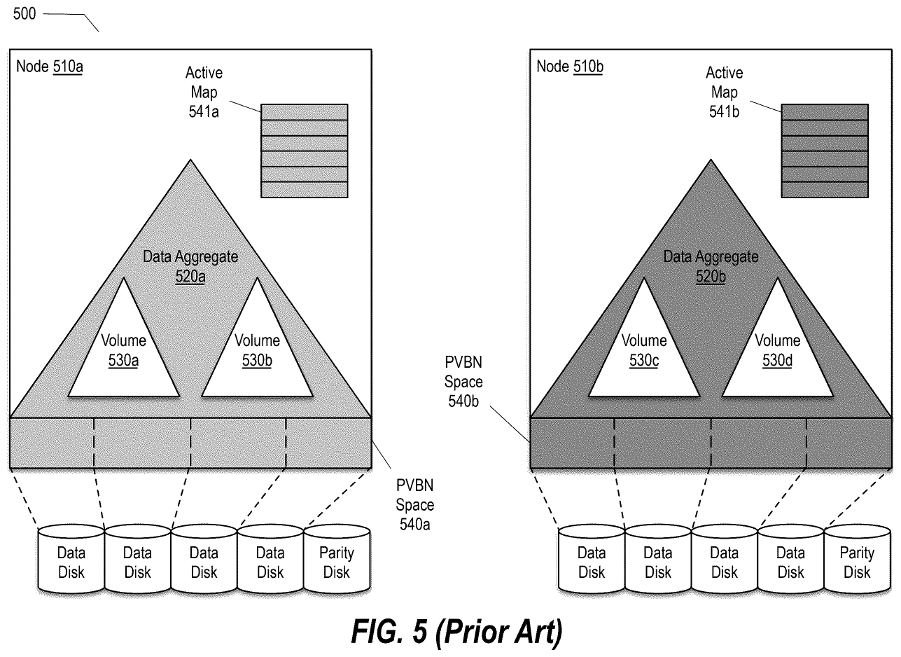

In general, various embodiments envision a cluster (e.g., cluster 100) in which every node (e.g., nodes 110a-b) can essentially talk to every storage device (e.g., disk) in the storage pod 145. This is in contrast to the distributed storage system architecture described with reference to FIG. 5. In examples described herein, all nodes (e.g., nodes 110a-b) of the cluster have visibility and read access to an entirety of a global PVBN space of the storage pod 145, for example, via an interconnect layer 142. As described further below, according to one embodiment, the storage within the storage pod 145 is grouped into distinct allocation areas (AAs) than can be assigned to a given dynamically extensible file system (DEFS) of a node to facilitate implementation disaggregated storage. In examples described herein, the AAs assigned to a given DEFS may be said to “own” the assigned AAs and the node owning the given DEFS has the exclusive write access to the associated PVBNs and the exclusive ability to perform write allocation from such blocks. In one embodiment, each node has its own view of a portion of the disaggregated storage represented by the assignment of, for example, via respective allocation area (AA) maps and active maps. This granular assignment of AAs and ability to fluidly change ownership of AAs as needed facilitates the elimination of per-node storage silos and provides higher and more predictable performance, which further translate into improved storage utilization and improvements in cost effectiveness of the storage solution.

Depending on the particular implementation, the interconnect layer 142 may be represented by an intermediate switching topology or some other interconnectivity layer or disk switching layer between the disks in the storage pod 145 and the nodes. Non-limiting examples of the interconnect layer 150 include one or more fiber channel switches or one or more non-volatile memory express (NVMe) fabric switches. Additional details regarding the storage pod 145, DEFSs, AA maps, active maps, and the use, ownership, and sharing (transferring of ownership) of AAs are described further below.

### Example Storage System Node

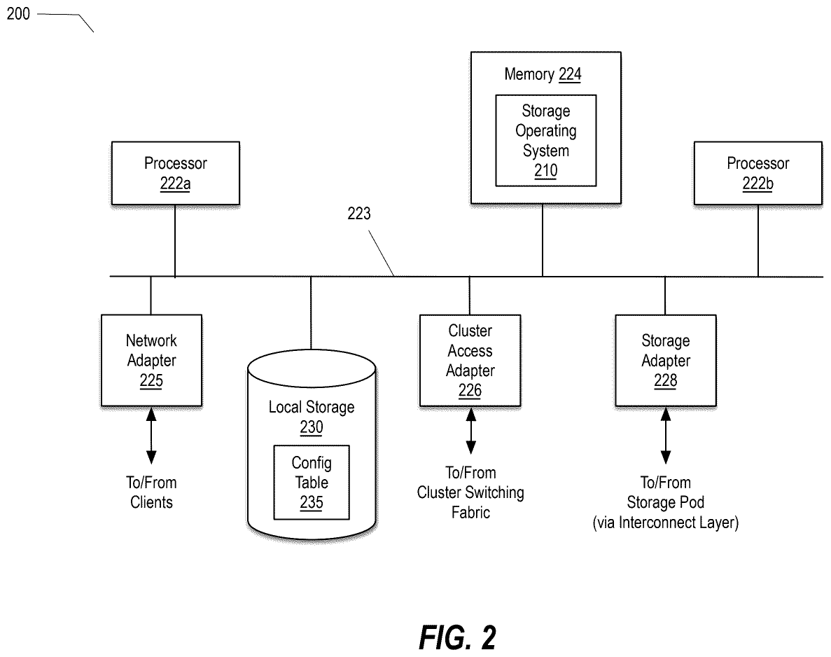

FIG. 2 is a block diagram of a node 200 that is illustratively embodied as a storage system comprising a plurality of processors (e.g., processors 222a-b), a memory 224, a network adapter 225, a cluster access adapter 226, a storage adapter 228 and local storage 230 interconnected by a system bus 223. Node 200 may be analogous to nodes 110a and 110b of FIG. 1. The local storage 230 comprises one or more storage devices, such as disks, utilized by the node to locally store configuration information (e.g., in configuration table 235). The cluster access adapter 226 comprises a plurality of ports adapted to couple the node 200 to other nodes of the cluster (e.g., cluster 100). Illustratively, Ethernet is used as the clustering protocol and interconnect media, although it will be apparent to those skilled in the art that other types of protocols and interconnects may be utilized within the cluster architecture described herein. Alternatively, where the network elements and disk elements are implemented on separate storage systems or computers, the cluster access adapter 226 is utilized by the network and disk element for communicating with other network and disk elements in the cluster.

In the context of the present example, each node 200 is illustratively embodied as a dual processor storage system executing a storage operating system 210 that implements a high-level module, such as a file system, to logically organize the information as a hierarchical structure of named directories, files and special types of files called virtual disks (hereinafter generally “blocks”) on the disks. However, it will be apparent to those of ordinary skill in the art that the node 200 may alternatively comprise a single or more than two processor system. Illustratively, one processor (e.g., processor 222a) may execute the functions of the network element (e.g., network element 120a or 120b) on the node, while the other processor (e.g., processor 222b) may execute the functions of the disk element (e.g., disk element 150a or 150b).

The memory 224 illustratively comprises storage locations that are addressable by the processors and adapters for storing software program code and data structures associated with the subject matter of the disclosure. The processor and adapters may, in turn, comprise processing elements and/or logic circuitry configured to execute the software code and manipulate the data structures. The storage operating system 210, portions of which is typically resident in memory and executed by the processing elements, functionally organizes the node 200 by, inter alia, invoking storage operations in support of the storage service implemented by the node. It will be apparent to those skilled in the art that other processing and memory means, including various computer readable media, may be used for storing and executing program instructions pertaining to the disclosure described herein.

The network adapter 225 comprises a plurality of ports adapted to couple the node 200 to one or more clients (e.g., client 180) over point-to-point links, wide area networks, virtual private networks implemented over a public network (Internet) or a shared local area network. The network adapter 225 thus may comprise the mechanical, electrical and signaling circuitry needed to connect the node to a network (e.g., computer network 140). Illustratively, the network may be embodied as an Ethernet network or a Fibre Channel (FC) network. Each client (e.g., client 180) may communicate with the node over network by exchanging discrete frames or packets of data according to pre-defined protocols, such as TCP/IP.

The storage adapter 228 cooperates with the storage operating system 210 executing on the node 200 to access information requested by the clients. The information may be stored on any type of attached array of writable storage device media such as video tape, optical, DVD, magnetic tape, bubble memory, electronic random access memory, micro-electromechanical and any other similar media adapted to store information, including data and parity information. However, as illustratively described herein, the information is stored on disks (e.g., associated with storage pod 145). The storage adapter comprises a plurality of ports having input/output (I/O) interface circuitry that couples to the disks over an I/O interconnect arrangement, such as a conventional high-performance, FC link topology.

Storage of information on each disk array may be implemented as one or more storage “volumes” that comprise a collection of physical storage disks or cloud volumes cooperating to define an overall logical arrangement of volume block number (VBN) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

While in the context of the present example, the node may be a physical host, it is to be appreciated the node may be implemented in virtual form. For example, a storage system may be run (e.g., on a VM or as a containerized instance, as the case may be) within a public cloud provider. As such, a cluster representing a distributed storage system may be comprised of multiple physical nodes (e.g., node 200) or multiple virtual nodes (virtual storage systems).

### Example Storage Operating System

To facilitate access to the disks (e.g., disks within one or more disk arrays of a storage pod, such as storage pod 145 of FIG. 1), a storage operating system (e.g., storage operating system 300, which may be analogous to storage operating system 210) may implement a write-anywhere file system that cooperates with one or more virtualization modules to “virtualize” the storage space provided by disks. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization module(s) allow the file system to further logically organize information as a hierarchical structure of blocks on the disks that are exported as named logical unit numbers (LUNs).

Illustratively, the storage operating system may be the Data ONTAP operating system available from NetApp, Inc., San Jose, Calif. that implements the WAFL® file system. However, it is expressly contemplated that any appropriate storage operating system may be enhanced for use in accordance with the inventive principles described herein. As such, where the term “WAFL” is employed, it should be taken broadly to refer to any file system that is otherwise adaptable to the teachings of this disclosure.

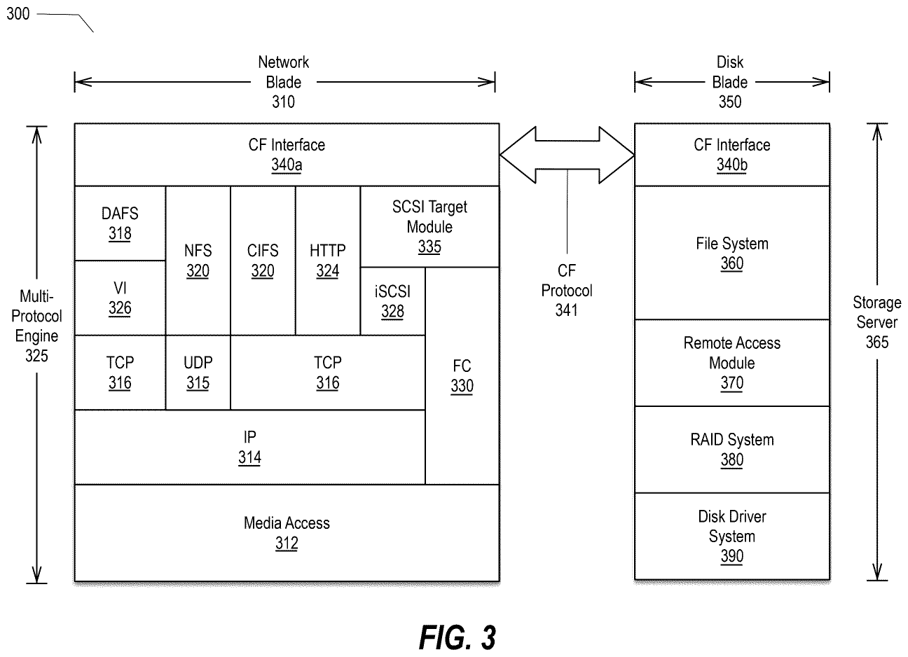

FIG. 3 is a block diagram illustrating a storage operating system 300 in accordance with an embodiment of the present disclosure. In the context of the present example, the storage operating system 300 is shown including a series of software layers organized to form an integrated network protocol stack or, more generally, a multi-protocol engine 325 that provides data paths for clients to access information stored on the node using block and file access protocols. The multi-protocol engine includes a media access layer 312 of network drivers (e.g., gigabit Ethernet drivers) that interfaces to network protocol layers, such as the IP layer 314 and its supporting transport mechanisms, the TCP layer 316 and the User Datagram Protocol (UDP) layer 315. A file system protocol layer provides multi-protocol file access and, to that end, includes support for the Direct Access File System (DAFS) protocol 318, the NFS protocol 320, the CIFS protocol 322 and the Hypertext Transfer Protocol (HTTP) protocol 324. A VI layer 326 implements the VI architecture to provide direct access transport (DAT) capabilities, such as RDMA, as required by the DAFS protocol 318. An iSCSI driver layer 328 provides block protocol access over the TCP/IP network protocol layers, while a FC driver layer 330 receives and transmits block access requests and responses to and from the node. The FC and iSCSI drivers provide FC-specific and iSCSI-specific access control to the blocks and, thus, manage exports of LUNs to either iSCSI or FCP or, alternatively, to both iSCSI and FCP when accessing the blocks on the node (e.g., node 200).

In addition, the storage operating system may include a series of software layers organized to form a storage server 365 that provides data paths for accessing information stored on the disks (e.g., disks 130) of the node. To that end, the storage server 365 includes a file system module 360 in cooperating relation with a remote access module 370, a RAID system module 380 and a disk driver system module 390. The RAID system 380 manages the storage and retrieval of information to and from the volumes/disks in accordance with I/O operations, while the disk driver system 390 implements a disk access protocol such as, e.g., the SCSI protocol.

The file system 360 may implement a virtualization system of the storage operating system 300 through the interaction with one or more virtualization modules illustratively embodied as, for example, a virtual disk (vdisk) module (not shown) and a SCSI target module 335. The SCSI target module 335 is generally disposed between the FC and iSCSI drivers 328, 330 and the file system 360 to provide a translation layer of the virtualization system between the block (LUN) space and the file system space, where LUNs are represented as blocks.

The file system 360 is illustratively a message-based system that provides logical volume management capabilities for use in access to the information stored on the storage devices, such as disks. That is, in addition to providing file system semantics, the file system 360 provides functions normally associated with a volume manager. These functions include (i) aggregation of the disks, (ii) aggregation of storage bandwidth of the disks, and (iii) reliability guarantees, such as mirroring and/or parity (RAID). The file system 360 illustratively implements an exemplary a file system having an on-disk format representation that is block-based using, e.g., 4 kilobyte (KB) blocks and using index nodes (“inodes”) to identify files and file attributes (such as creation time, access permissions, size and block location). The file system may use files to store metadata describing the layout of its file system; these metadata files may include, among others, an inode file. A file handle (e.g., an identifier that includes an inode number) may be used to retrieve an inode from disk.

Broadly stated, all inodes of the write-anywhere file system are organized into the inode file. A file system (fs) info block specifies the layout of information in the file system and includes an inode of a file that includes all other inodes of the file system. Each logical volume (file system) has an fsinfo block that is preferably stored at a fixed location within, e.g., a RAID group. The inode of the inode file may directly reference (point to) data blocks of the inode file or may reference indirect blocks of the inode file that, in turn, reference data blocks of the inode file. Within each data block of the inode file are embedded inodes, each of which may reference indirect blocks that, in turn, reference data blocks of a file.

Operationally, a request from a client (e.g., client 180) is forwarded as a packet over a computer network (e.g., computer network 140) and onto a node (e.g., node 200) where it is received at a network adapter (e.g., network adaptor 225). A network driver (of layer 312 or layer 330) processes the packet and, if appropriate, passes it on to a network protocol and file access layer for additional processing prior to forwarding to the write-anywhere file system 360. Here, the file system generates operations to load (retrieve) the requested data from disk 130 if it is not resident “in core”, i.e., in memory 224. If the information is not in memory, the file system 360 indexes into the inode file using the inode number to access an appropriate entry and retrieve a logical VBN. The file system then passes a message structure including the logical VBN to the RAID system 380; the logical VBN is mapped to a disk identifier and disk block number (disk,dbn) and sent to an appropriate driver (e.g., SCSI) of the disk driver system 390. The disk driver accesses the dbn from the specified disk 130 and loads the requested data block(s) in memory for processing by the node. Upon completion of the request, the node (and operating system) returns a reply to the client 180 over the network 140.

The remote access module 370 is operatively interfaced between the file system module 360 and the RAID system module 380. Remote access module 370 is illustratively configured as part of the file system to implement the functionality to determine whether a newly created data container, such as a subdirectory, should be stored locally or remotely. Alternatively, the remote access module 370 may be separate from the file system. As such, the description of the remote access module being part of the file system should be taken as exemplary only. Further, the remote access module 370 determines which remote flexible volume should store a new subdirectory if a determination is made that the subdirectory is to be stored remotely. More generally, the remote access module 370 implements the heuristics algorithms used for the adaptive data placement. However, it should be noted that the use of a remote access module should be taken as illustrative. In alternative aspects, the functionality may be integrated into the file system or other module of the storage operating system. As such, the description of the remote access module 370 performing certain functions should be taken as exemplary only.

It should be noted that the software “path” through the storage operating system layers described above needed to perform data storage access for the client request received at the node may alternatively be implemented in hardware. That is, a storage access request data path may be implemented as logic circuitry embodied within a field programmable gate array (FPGA) or an application specific integrated circuit (ASIC). This type of hardware implementation increases the performance of the storage service provided by node 200 in response to a request issued by client 180. Alternatively, the processing elements of adapters 225, 228 may be configured to offload some or all of the packet processing and storage access operations, respectively, from processor 222, to thereby increase the performance of the storage service provided by the node. It is expressly contemplated that the various processes, architectures and procedures described herein can be implemented in hardware, firmware or software.

As used herein, the term “storage operating system” generally refers to the computer-executable code operable on a computer to perform a storage function that manages data access and may, in the case of a node (e.g., node 200), implement data access semantics of a general purpose operating system. The storage operating system can also be implemented as a microkernel, an application program operating over a general-purpose operating system, such as UNIX or Windows NT, or as a general-purpose operating system with configurable functionality, which is configured for storage applications as described herein.

In addition, it will be understood to those skilled in the art that aspects of the disclosure described herein may apply to any type of special-purpose (e.g., file server, filer or storage serving appliance) or general-purpose computer, including a standalone computer or portion thereof, embodied as or including a storage system. Moreover, the teachings contained herein can be adapted to a variety of storage system architectures including, but not limited to, a network-attached storage environment, a storage area network and disk assembly directly attached to a client or host computer. The term “storage system” should therefore be taken broadly to include such arrangements in addition to any subsystems configured to perform a storage function and associated with other equipment or systems. It should be noted that while this description is written in terms of a write anywhere file system, the teachings of the subject matter may be utilized with any suitable file system, including a write in place file system.

### Example Cluster Fabric (CF) Protocol

Illustratively, the storage server 365 is embodied as disk element (or disk blade 350, which may be analogous to disk element 150a or 150b) of the storage operating system 300 to service one or more volumes of array 160. In addition, the multi-protocol engine 325 is embodied as network element (or network blade 310, which may be analogous to network element 120a or 120b) to (i) perform protocol termination with respect to a client issuing incoming data access request packets over the network (e.g., network 140), as well as (ii) redirect those data access requests to any storage server 365 of the cluster (e.g., cluster 100). Moreover, the network element 310 and disk element 350 cooperate to provide a highly scalable, distributed storage system architecture of the cluster. To that end, each module may include a cluster fabric (CF) interface module (e.g., CF interface 340a and 340b) adapted to implement intra-cluster communication among the nodes (e.g., node 110a and 110b). In the context of a distributed storage architecture as described below with reference to FIG. 5 in which node-level aggregates are employed, the CF protocol facilitates, among other things, internode communications relating to data access requests. It is to be appreciated such internode communications relating to data access requests are not needed in the context of a distributed storage architecture as described below with reference to FIG. 6A in which each node of a cluster has visibility and access to the entirety of a global PVBN space of a storage pod (via their respective DEFSs). However, in various embodiments, some limited amount of internode communications, for example, relating to storage space reporting (or simply space reporting) and storage space requests (e.g., requests for donations of AAs) continue to be useful. As described further below, such internode communications may make use of the CF protocol or other forms of internode communications, including message passing via on-wire communications and/or the use of one or more persistent message queues (or on-disk message queues), which may make use of the fact that all nodes can read from all disk of a storage pod. For example, a persistent message queue may be maintained at the node and/or DEFS-level of granularity in which each node and/or DEFS has a message queue to which others can post messages destined for the node or DEFS (as the case may be). In one embodiment, each DEFS has an associated inbound queue on which it receives messages sent by another DEFS in the cluster and an associated outbound queue on which it posts messages intended for delivery to another DEFS in the cluster

The protocol layers, e.g., the NFS/CIFS layers and the iSCSI/IFC layers, of the network element 310 may function as protocol servers that translate file-based and block based data access requests from clients into CF protocol messages used for communication with the disk element 350. That is, the network element servers may convert the incoming data access requests into file system primitive operations (commands) that are embedded within CF messages by the CF interface module 340 for transmission to the disk elements of the cluster.

Further, in an illustrative aspect of the disclosure, the network element and disk element are implemented as separately scheduled processes of storage operating system 300; however, in an alternate aspect, the modules may be implemented as pieces of code within a single operating system process. Communication between a network element and disk element may thus illustratively be effected through the use of message passing between the modules although, in the case of remote communication between a network element and disk element of different nodes, such message passing occurs over a cluster switching fabric (e.g., cluster switching fabric 151). A known message-passing mechanism provided by the storage operating system to transfer information between modules (processes) is the Inter Process Communication (IPC) mechanism. The protocol used with the IPC mechanism is illustratively a generic file and/or block-based “agnostic” CF protocol that comprises a collection of methods/functions constituting a CF application programming interface (API). Examples of such an agnostic protocol are the SpinFS and SpinNP protocols available from NetApp, Inc.

The CF interface module 340 implements the CF protocol for communicating file system commands among the nodes or modules of cluster. Communication may be illustratively effected by the disk element exposing the CF API to which a network element (or another disk element) issues calls. To that end, the CF interface module 340 may be organized as a CF encoder and CF decoder. The CF encoder of, e.g., CF interface 340a on network element 310 encapsulates a CF message as (i) a local procedure call (LPC) when communicating a file system command to a disk element 350 residing on the same node 200 or (ii) a remote procedure call (RPC) when communicating the command to a disk element residing on a remote node of the cluster 100. In either case, the CF decoder of CF interface 340b on disk element 350 de-encapsulates the CF message and processes the file system command.

Illustratively, the remote access module 370 may utilize CF messages to communicate with remote nodes to collect information relating to remote flexible volumes. A CF message is used for RPC communication over the switching fabric between remote modules of the cluster; however, it should be understood that the term “CF message” may be used generally to refer to LPC and RPC communication between modules of the cluster. The CF message includes a media access layer, an IP layer, a UDP layer, a reliable connection (RC) layer and a CF protocol layer. The CF protocol is a generic file system protocol that may convey file system commands related to operations contained within client requests to access data containers stored on the cluster; the CF protocol layer is that portion of a message that carries the file system commands. Illustratively, the CF protocol is datagram based and, as such, involves transmission of messages or “envelopes” in a reliable manner from a source (e.g., a network element 310) to a destination (e.g., a disk element 350). The RC layer implements a reliable transport protocol that is adapted to process such envelopes in accordance with a connectionless protocol, such as UDP.

### Example File System Layout

In one embodiment, a data container is represented in the write-anywhere file system as an inode data structure adapted for storage on the disks of a storage pod (e.g., storage pod 145). In such an embodiment, an inode includes a metadata section and a data section. The information stored in the metadata section of each inode describes the data container (e.g., a file, a snapshot, etc.) and, as such, includes the type (e.g., regular, directory, vdisk) of file, its size, time stamps (e.g., access and/or modification time) and ownership (e.g., user identifier (UID) and group ID (GID), of the file, and a generation number. The contents of the data section of each inode may be interpreted differently depending upon the type of file (inode) defined within the type field. For example, the data section of a directory inode includes metadata controlled by the file system, whereas the data section of a regular inode includes file system data. In this latter case, the data section includes a representation of the data associated with the file.

Specifically, the data section of a regular on-disk inode may include file system data or pointers, the latter referencing 4 KB data blocks on disk used to store the file system data. Each pointer is preferably a logical VBN to facilitate efficiency among the file system and the RAID system when accessing the data on disks. Given the restricted size (e.g., 128 bytes) of the inode, file system data having a size that is less than or equal to 64 bytes is represented, in its entirety, within the data section of that inode. However, if the length of the contents of the data container exceeds 64 bytes but less than or equal to 64 KB, then the data section of the inode (e.g., a first level inode) comprises up to 16 pointers, each of which references a 4 KB block of data on the disk.

Moreover, if the size of the data is greater than 64 KB but less than or equal to 64 megabytes (MB), then each pointer in the data section of the inode (e.g., a second level inode) references an indirect block (e.g., a first level L1 block) that contains 224 pointers, each of which references a 4 KB data block on disk. For file system data having a size greater than 64 MB, each pointer in the data section of the inode (e.g., a third level L3 inode) references a double-indirect block (e.g., a second level L2 block) that contains 224 pointers, each referencing an indirect (e.g., a first level L1) block. The indirect block, in turn, which contains 224 pointers, each of which references a 4 kB data block on disk. When accessing a file, each block of the file may be loaded from disk into memory (e.g., memory 224). In other embodiments, higher levels are also possible that may be used to handle larger data container sizes.

When an on-disk inode (or block) is loaded from disk into memory, its corresponding in-core structure embeds the on-disk structure. The in-core structure is a block of memory that stores the on-disk structure plus additional information needed to manage data in the memory (but not on disk). The additional information may include, e.g., a “dirty” bit. After data in the inode (or block) is updated/modified as instructed by, e.g., a write operation, the modified data is marked “dirty” using the dirty bit so that the inode (block) can be subsequently “flushed” (stored) to disk.

According to one embodiment, a file in a file system comprises a buffer tree that provides an internal representation of blocks for a file loaded into memory and maintained by the write-anywhere file system 360. A root (top-level) buffer, such as the data section embedded in an inode, references indirect (e.g., level 1) blocks. In other embodiments, there may be additional levels of indirect blocks (e.g., level 2, level 3) depending upon the size of the file. The indirect blocks (e.g., and inode) includes pointers that ultimately reference data blocks used to store the actual data of the file. That is, the data of file are contained in data blocks and the locations of these blocks are stored in the indirect blocks of the file. Each level 1 indirect block may include pointers to as many as 224 data blocks. According to the “write anywhere” nature of the file system, these blocks may be located anywhere on the disks.

In one embodiment, a file system layout is provided that apportions an underlying physical volume into one or more virtual volumes (or flexible volumes) of a storage system, such as node 200. In such an embodiment, the underlying physical volume is an aggregate comprising one or more groups of disks, such as RAID groups, of the node. The aggregate has its own physical volume block number (PVBN) space and maintains metadata, such as block allocation structures, within that PVBN space. Each flexible volume has its own virtual volume block number (VVBN) space and maintains metadata, such as block allocation structures, within that VVBN space. Each flexible volume is a file system that is associated with a container file; the container file is a file in the aggregate that contains all blocks used by the flexible volume. Moreover, each flexible volume comprises data blocks and indirect blocks that contain block pointers that point at either other indirect blocks or data blocks.

In a further embodiment, PVBNs are used as block pointers within buffer trees of files stored in a flexible volume. This “hybrid” flexible volume example involves the insertion of only the PVBN in the parent indirect block (e.g., inode or indirect block). On a read path of a logical volume, a “logical” volume (vol) info block has one or more pointers that reference one or more fsinfo blocks, each of which, in turn, points to an inode file and its corresponding inode buffer tree. The read path on a flexible volume is generally the same, following PVBNs (instead of VVBNs) to find appropriate locations of blocks; in this context, the read path (and corresponding read performance) of a flexible volume is substantially similar to that of a physical volume. Translation from PVBN-to-disk,dbn occurs at the file system/RAID system boundary of the storage operating system 300.

In a dual VBN hybrid flexible volume example, both a PVBN and its corresponding VVBN are inserted in the parent indirect blocks in the buffer tree of a file. That is, the PVBN and VVBN are stored as a pair for each block pointer in most buffer tree structures that have pointers to other blocks, e.g., level 1 (L1) indirect blocks, inode file level 0 (L0) blocks.

A root (top-level) buffer, such as the data section embedded in an inode, references indirect (e.g., level 1) blocks. Note that there may be additional levels of indirect blocks (e.g., level 2, level 3) depending upon the size of the file. The indirect blocks (and inode) include PVBN/VVBN pointer pair structures that ultimately reference data blocks used to store the actual data of the file. The PVBNs reference locations on disks of the aggregate, whereas the VVBNs reference locations within files of the flexible volume. The use of PVBNs as block pointers in the indirect blocks provides efficiencies in the read paths, while the use of VVBN block pointers provides efficient access to required metadata. That is, when freeing a block of a file, the parent indirect block in the file contains readily available VVBN block pointers, which avoids the latency associated with accessing an owner map to perform PVBN-to-VVBN translations; yet, on the read path, the PVBN is available.

### Example Hierarchical Inode Tree

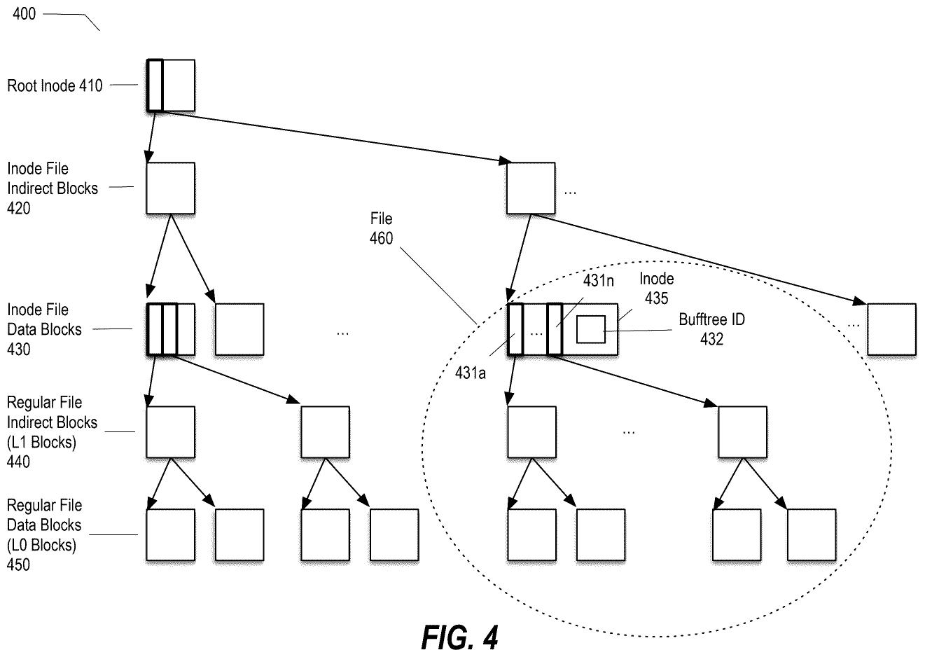

FIG. 4 is a block diagram illustrating a tree of blocks 400 representing a simplified view of an example a file system layout in accordance with an embodiment of the present disclosure. In one embodiment, the data storage system nodes (e.g., data storage systems 110a-b) make use of a write anywhere file system (e.g., the WAFL® file system). The write anywhere file system may represent a UNIX® compatible file system that is optimized for network file access. In the context of the present example, the write anywhere file system is a block-based file system that represents file system data (e.g., a block map file and an inode map file), metadata files, and data containers (e.g., volumes, subdirectories, and regular files) in a tree of blocks (e.g., tree of blocks 400). Keeping metadata in files allows the file system to write metadata blocks anywhere on disk and makes it easier to increase the size of the file system on the fly.

In this simplified example, the tree of blocks 400 has a root inode 410, which describes an inode map file (not shown), made up of inode file indirect blocks 420 and inode file data blocks 430. In this example, the file system uses inodes (e.g., inode file data blocks 430) to describe data containers representing files (e.g., file 460). In one embodiment, each inode contains 16 block pointers to indicate which blocks (e.g., of 4 KB) belong to a given data container (e.g., a file). Inodes for data containers smaller than 64 KB may use the 156 block pointers to point to file data blocks or simply data blocks (e.g., regular file data blocks, which may also be referred to herein as L0 blocks 450). Inodes for files smaller than 64 MB may point to indirect blocks (e.g., regular file indirect blocks, which may also be referred to herein as L1 blocks 440), which point to actual file data. Inodes for larger files or data containers may point to doubly indirect blocks. For very small files, data may be stored in the inode itself in place of the block pointers.

In the context of the present example, an inode 435 is shown including a buffer tree identifier (i.e., bufftree ID 432) and pointers 431a-n (e.g., PVBNs) to indirect (or L1) blocks that in turn point to data (or L0) blocks containing the file data. The bufftree ID 432 may represent a file ID assigned to the file 460 and may be used to facilitate performance of context checking during processing of internal (e.g., those initiated by workflows or subsystems of the storage system) read requests and/or external (e.g., those initiated by clients of the storage system) read requests to avoid returning stale data to the requestor. In various embodiments described herein, given the fact that files may be moved from one DEFS to another within the cluster, it is desirable for the file ID to be unique across the cluster to avoid file ID collisions.

As will be appreciated by those skilled in the art given the above-described file system layout, yet another advantage of DEFSs are their ability to facilitate storage space balancing and/or load balancing. This comes from the fact that the entire global PVBN space of a storage pod is visible to all DEFSs of the cluster and therefore any given DEFS can get access to an entire file by copying the top-most PVBN from the inode on another tree.

Example of a Distributed Storage System Architecture with Storage Silos

FIG. 5 is a block diagram illustrating a distributed storage system architecture 500 in which the entirety of a given disk and a given RAID group are owned by an aggregate and the aggregate file system is only visible from one node, thereby resulting in silos of storage space. In the context of FIG. 5, node 510a and node 510b may represent a two-node cluster in which the nodes are high-availability (HA) partners. For example, one node may represent a primary node and the other may represent a secondary node in which pairwise disk connectively supports a pairwise failover model. As shown, each node includes respective active maps (e.g., active map 541a and active map 541b) and a sets of disks (in this case, ten disks) they can talk to. The nodes may partition the disks among themselves as aggregates (e.g., data aggregate 520a and data aggregate 520b) and at steady state both nodes will work on their own subset of disks representing a one or more RAID groups (in this case, four data disks and one parity disk, forming a single RAID group). A RAID layer or subsystem (not shown) of a storage operating system (not shown) of each node may present respective separate and independent PVBN spaces (e.g., PVBN space 540a and PVBN space 540b) to a file system layer (not shown) of the node.

In this example, therefore, data aggregate 520a has visibility only to a first PVBN space (e.g., PVBN space 540a) and data aggregate 520b has visibility only to a second PVBN space (e.g., PVBN space 540b). When data is stored to volume 530a or 530b, it is striped across the subset of disks that are part of data aggregate 520a; and when data is stored to volume 530c or 530d, it is are striped across the subset of disks that are part of data aggregate 520b. Active map 541a is a data structure (e.g., a bit map with one bit per PVBN) that that identifies the PVBNs within PVBN space 540a that are in use by data aggregate 520a. Similarly, active map 541b is a data structure (e.g., a bit map with one bit per PVBN) that that identifies the PVBNs within PVBN space 540b that are in use by data aggregate 520b.

As can be seen, for any given disk, the entire disk is owned by a particular aggregate and the aggregate file system is only visible from one node. Similarly, for any given RAID group, the available storage space of the entire RAID group is useable only by a single node. There are various other disadvantages to the architecture shown in FIG. 5. For example, moving a volume from one aggregate to another requires copying of data (e.g., reading all the blocks used by the volume and writing them to the new location), with an elaborate handover sequence between the aggregates involved. Additionally, there are scenarios in which one data aggregate may run out of storage space while the other still has plentiful free storage space, resulting in ineffective usage of the storage space provided by the disks. While the size of the PVBN space of an aggregate may be increased, doing so typically requires an administrative user to monitor the storage space on each node-level aggregate and add one or more disks and/or RAID groups to the aggregate. As described further below with reference to FIG. 6A, with DEFSs storage space is added to a common pool of storage referred to herein as a “storage pod” and space is available for consumption by any DEFS in the cluster, thereby making space management much simpler and facilitating the automatic balancing of storage space without administrator involvement.

### Example Distributed System Architecture Providing Disaggregated Storage

Before getting into the details of a particular example, various properties, constructs, and principles relating to the use and implementation of DEFSs will now be discussed. As noted above, it is desirable to make the global PVBN space of the entire storage pool available on each DEFS of a data pod, which may include one or more clusters. This feature facilitates the performance of, among other things, instant copy-free moves of volumes from one DEFS to another, for example, in connection with performing load balancing. Creating clones on remote nodes for load balancing is yet another benefit. With a global PVBN space, support for global data deduplication can also be supported rather than deduplication being limited to node-level aggregates.

It is also beneficial, in terms of performance, to avoid the use of access control mechanism, such as locks, to coordinate write accesses and write allocation among nodes generally and DEFSs specifically. Such access control mechanisms may be eliminated by specifying, at a per-DEFS level, those portions of the disaggregated storage of the storage pod to which a given DEFS has exclusive write access. For example, as described further below, a DEFS may be limited to use of only the AAs associated with (assigned to or owned by) the DEFS for performing write allocation and write accesses during a CP. Advantageously, given the visibility into the entire global PVBN space, reads can be performed by any DEFS of the cluster from all the PVBNs in the storage pod.

Each DEFS of a given cluster (or data pod, as the case may be) may start at its own super block. As shown and described with reference to FIG. 6A, a predefined AA (e.g., the first AA) in storage pod may be dedicated for super blocks. In one embodiment, a set of RAID stripes within the predefined super block AA (e.g., the first AA of the storage pod) may be dedicated for super blocks. In this predefined super block AA, ownership may be specified at the granularity of a single RAID stripe instead of at the AA granularity of multiple RAID stripes representing one or more GBs (e.g., between approximately 1 GB and 10 GB) of storage space. The location of a super block of a given DEFS can be mathematically derived using an identifier (a DEFS ID) associated with the given DEFS. Since the RAID stripe is already reserved for a super block, it can be replicated on N disks.

Each DEFS has AAs associated with it, which may be thought of conceptually as the DEFS owning those AAs. In one embodiment, AAs may be tracked within an AA map and persisted within the DEFS filesystem. An AA map may include the DEFS ID in an AA index. While AA ownership information regarding other DEFSs in the cluster may be cached in the AA map of a given DEFS, which may be useful during the PVBN free path, for example, to facilitate freeing of PVBNs of an AA not owned by the given DEFS (which may arise in situations in which partial AAs are donated from one DEFS to another), the authoritative source information regarding the AAs owned by a given DEFS may be presumed to be in the AA map of the given DEFS.

In support of avoiding storage silos and supporting the more fluid use of disk space across all nodes of a cluster, DEFSs may be allowed to donate partially or completely free AAs to other DEFSs.

Each DEFS may have its own label information kept in the file system. The label information may be kept in the super block or another well-known location outside of the file system.

In various examples, there can be multiple DEFSs on a RAID tree. That is, there may be a many-to-one association between DEFSs and a RAID tree, in which each DEFS may have a reference on the RAID tree. The RAID tree can still have multiple RAID groups. In various examples described herein, it is assumed the PVBN space provided by the RAID tree is continuous.

It may be helpful to have a root DEFS and a data DEFS that are transparent to other subsystems. These DEFSs may be useful for storing information that might be needed before the file system is brought online. Examples of such information may include controller (node) failover (CFO) and storage failover (SFO) properties/policies. HA is one example of where it might be helpful to bring up a controller (node) failover root DEFS first before giving back the storage failover data DEFSs. HA coordination of bringing down a given DEFS on takeover/giveback may be handled by the file system (e.g., the WAFL® file system) since the RAID tree would be up until the node is shutdown.

DEFS data structures (e.g., DEFS bit maps at the PVBN level, such as active maps and reference count (refcount) maps) may be sparse. That is, they may represent the entire global PVBN space, but only include valid truth values for PVBNs of AAs that are owned by the particular DEFS with which they are associated. When validation of these bit maps is performed by or on behalf of a particular DEFS, the bits should be validated only for the AA areas owned by the particular DEFS. When using such sparce data structures, to get the complete picture of the PVBN space, the data structures in all of the nodes should be taken into consideration. While various DEFS data structures may be discussed herein as if they were separate metafiles, it is to be appreciated, given the visibility by each node into the entire global PVBN space, one or more of such DEFS data structures may be represented as cluster-wide metafiles. Such a cluster-wide metafile may be persisted in a private inode space that is not accessible to end users and the relevant portions for a particular DEFS may be located based on the DEFS ID of the particular DEFS, for example, which may be associated with the appropriate inode (e.g., an L0 block). Similarly, the entirety of such a cluster-wide metafile may be accessible based on a cluster ID, for example, which may be associated with a higher-level inode in the hierarchy (e.g., an L1 block). In any event, each node should generally have all the information it needs to work independently until and unless it runs out of storage space or meets a predetermined or configurable threshold of a storage space metric (e.g., a free space metric or a used space metric), for example, relative to the other nodes of the cluster. At that point, as described further below, as part of a space monitoring and/or a space balancing process, the node may request a portion of AAs of DEFSs owned by one or more of such other nodes be donated so as to increase the useable storage space of one or more DEFSs of the node at issue.

FIG. 6A is a block diagram illustrating a distributed storage system architecture 600 that provides disaggregated storage in accordance with an embodiment of the present disclosure. Various architectural advantages of the proposed distributed storage system architecture and mechanisms for providing and making use of disaggregated storage include, but are not limited to, the ability to perform automatic space balancing among DEFSs, perform elastic node growth and shrinkage for a cluster, perform elastic storage growth of the storage pod, perform zero-copy file and volume move (migration), perform distributed RAID rebuild, achieve HA cost reduction using volume rehosting, create remote clones, and perform global data deduplication.

In the context of the present example, the nodes (e.g., node 610a and 610b) of a cluster, which may represent a data pod or include multiple data pods, each include respective data dynamically extensible file systems (DEFSs) (e.g., data DEFS 620a and data DEFS 620b) and respective log DEFSs (e.g., log DEFS 625a and log DEFS 625b). In general, data DEFSs may be used for persisting data on behalf of clients (e.g., client 180), whereas log DEFSs may be used to maintain an operation log or journal of certain storage operations within the journaling storage media that have been performed since the last CP.

It should be noted that while for simplicity only two nodes, which may be configured as part of an HA pair for fault tolerance and nondisruptive operations, are shown in the illustrative cluster depicted in FIG. 6A, there may be one or more additional nodes in a given cluster. For example, there may be multiple HA pairs within a cluster (or a data pod of the cluster, which may represent a mechanism to limit the fault domain). As such, the description of this two-node cluster should be taken as illustrative only. Furthermore, while in some examples HA may be achieved by defining pairs of nodes within a cluster as HA partners (e.g., with one node designated as the primary node and the other designated as the secondary), in alternative examples any other node within a cluster may be allowed to step in after a failure of a given node without defining HA pairs.

As discussed above, one or more volumes (e.g., volumes 630a-m and volumes 630n-x) or LUNs (not shown) may be created by or on behalf of customers for hosting/storing their enterprise application data within respective DEFSs (e.g., data DEFSs 620a and 620b).

While additional data structures may be employed, in this example, each DEFS is shown being associated with respective AA maps (indexed by AA ID) and active maps (indexed by PVBN). For example, log DEFS 625a may utilize AA map 627a to track those of the AAs within a global PVBN space 640 of storage pod 645 (which may be analogous to storage pod 145) that are owned by log DEFS 625a and may utilize active map 626a to track at a PVBN level of granularity which of the PVBNs of its AAs are in use; log DEFS 625b may utilize AA map 627b to track those of the AAs within the global PVBN space 640 that are owned by log DEFS 625b and may utilize active map 626b to track at a PVBN level of granularity which of the PVBNs of its AAs are in use; data DEFS 620a may utilize AA map 622a to track those of the AAs within the global PVBN space 640 that are owned by data DEFS 620a and may utilize active map 621a to track at a PVBN level of granularity which of the PVBNs of its AAs are in use; and data DEFS 620b may utilize AA map 622b to track those of the AAs within the global PVBN space 640 that are owned by data DEFS 620b and may utilize active map 621b to track at a PVBN level of granularity which of the PVBNs of its AAs are in use.

In this example, each DEFS of a given node has visibility and accessibility into the entire global PVBN address space 640 and any AA (except for a predefined superblock AA or DEFS region 642) within the global PVBN address space 640 may be assigned to any DEFS within the cluster. By extension, each node has visibility and accessibility into the entire global PVBN address space 640 via its DEFSs. As noted above, the respective AA maps of the DEFSs define which PVBNs to which the DEFSs have exclusive write access. AAs within the global PVBN space 640 shaded in light gray, such as AA 641a, can only be written to by node 610a as a result of their ownership by or assignment to data DEFS 620a. Similarly AAs within the global PVBN space 640 shaded in dark gray, such as AA 641b, can only be written to by node 610b as a result of their ownership by or assignment to data DEFS 620b.

Returning to DEFS region 642, it may be part of a superblock AA (or super AA). According to one embodiment, a layout of the DEFS region 642 is proposed to maintain multiple DEFS labels (not shown) on a per DEFS basis within a well-known area. For example, each DEFS label may be a 4 KB block on persistent storage (e.g., disk storage) sitting alongside a superblock (not shown) of a given DEFS that is located outside of the file system. In this manner, the information within a given DEFS label is accessible even when the DEFS is offline. The ability to read and write a DEFS label when a DEFS is offline should be provided so as to support, among other things, diagnostic-level workflows like maintaining DEFS persistent information to determine whether a given DEFS has been marked for being inconsistent, offline, restricted, etc.

In the context of FIG. 6A, the DEFS region 642 is a predefined or configurable AA (e.g., the first AA of the storage pod 645—AA0). The DEFS region 642 is not assigned to any DEFS (as indicated by its lack of shading). As described further below, the DEFS region 642 may have an array of superblocks and DEFS labels (one for each DEFS in the cluster) which are dedicated to each DEFS and the DEFS region 642 may be indexed by a DEFS ID. The DEFS ID may start at index 1 and in the context of the present example includes four superblock and four DEFS label blocks. The DEFS label can act as a RAID label for the DEFS and can be written out of a CP and can store information that needs to be kept outside of the file system. As described further below, a given DEFS label may be used to store attributes or fields including flags that may be set by various subsystems or workflows of the storage system to indicate a current state of a corresponding DEFS. In one embodiment, a DEFS label block is written across a RAID stripe for redundancy. As information stored in the DEFS labels is important to the operations of the distributed storage system, one or more techniques may be employed to protect against loss of such information, for example, redundancy. In the context of the present example, there are four copies of a given DEFS label written at the same PVBNs owned by the DEFS at issue. For example, in one embodiment, each DEFS owns 126 blocks per disk in the RAID strip in AA0. Further discussion regarding various use cases and the content of the DEFS labels is provided below.

In the context of the present example, it is assumed after establishment of the disaggregated storage within the storage pod 645 and after the original assignment of ownership of AAs to data DEFS 620a and data DEFS 620b, some AAs have been transferred from data DEFS 620a to data DEFS 620b and/or some AAs have been transferred from data DEFS 620b to data DEFS 620a. As such, the different shades of grayscale of entries within the AA maps are intended to represent potential caching that may be performed regarding ownership of AAs owned by other DEFSs in the cluster. For example, assuming ownership of a partial AA has been transferred from data DEFS 620a to data DEFS 620b as part of an ownership change performed in support of space balancing, when data DEFS 620a would like to free a given PVBN (e.g., when the given PVBN is no longer referenced by data DEFS 620a a result of data deletion or otherwise), data DEFS 620a should send a request to free the PVBN to the new owner (in this case, data DEFS 620b). This is due to the fact that in various embodiments, only the current owner of a particular AA is allowed to perform any modify operations on the particular AA. While not necessary for understanding the implementation and use of DEFS labels, further explanation regarding space balancing and AA ownership change is provided in co-pending U.S. patent application Ser. No. 19/068,324 and co-pending U.S. patent application Ser. No. 18/595,785, filed on Mar. 5, 2024, both of which are hereby incorporated by reference in their entirety for all purposes.

Those skilled in the art will appreciate disaggregation of the storage space as discussed herein can be leveraged for cost-effective scaling of infrastructure. For example, the disaggregated storage allows more applications to share the same underlying storage infrastructure. Given that each DEFS represents an independent file system, the use of multiple of such DEFSs combine to create a cluster-wide distributed file system since all of the DEFSs within a cluster share a global PVBN space (e.g., global PVBN space 640). This provides the unique ability to independently scale each independent DEFS as well as enables fault isolation and repair in a manner different from existing distributed file systems.

Additional aspects of FIG. 6A will now be described in connection with a discussion of FIG. 6B, which represents a high-level flow diagram illustrating operations for establishing disaggregated storage within a storage pod (e.g., storage pod 645). The processing described with reference to FIG. 6B, may be performed by a combination of a file system (e.g., file system 360) and a RAID system (e.g., RAID system 380), for example, during or after an initial boot up.

At block 661, the storage pod is created based on a set of disks made available for use by the cluster. For example, job may be executed by a management plane of the cluster to create the storage pod and assign the disks to the cluster. Depending on the particular implementation and the deployment environment (e.g., on-prem versus cloud), the disks may be associated with of one or more disk arrays or one or more storage shelves or persistent storage in the form of cloud volumes provided by a cloud provider from a pool of storage devices within a cloud environment. For simplicity, cloud volumes may also be referred to herein as “disks.” The disks may be HDDs or SSDs.

At block 662, the storage space of the set of disks may be divided or partitioned into uniform-sized AAs. The set of disks may be grouped to form multiple RAID groups (e.g., RAID group 650a and 650b) depending on the RAID level (e.g., RAID 4, RAID 5, or other). Multiple RAID stripes may then be grouped to form individual AAs. As noted above, an AA (e.g., AA 641a or AA 641b) may be a large chunk representing one or more GB of storage space and preferably accommodates multiple SSD erase blocks work of data. In one embodiment, the size of the AAs is tuned for the particular file system. The size of the AAs may also take into consideration a desire to reduce the need for performing space balancing so as to minimize the need for internode (e.g., East-West) communications/traffic. In some examples, the size of the AAs may be between about 1 GB to 10 GB. As can be seen in FIG. 6A, dividing the storage pod 645 into AAs allows available storage space associated with any given disk or any RAID group to be use across many/all nodes in the cluster without creating silos of space in each node. For example, at the granularity of an individual AA, available storage space within the storage pod 645 may be assigned to any given node in the cluster (e.g., by way of the given node's DEFS(s)). For example, in the context of FIG. 6A, AA 641a and the other AAs shaded in light gray are currently assigned to (or owned by) data DEFS 620a (which has a corresponding light gray shading). Similarly, AA 641b and the other AAs shaded in dark gray are currently assigned to (or owned by) data DEFS 620b (which has a corresponding light gray shading).

At block 663, ownership of the AAs is assigned to the DEFSs of the nodes of the cluster. According to one embodiment, an effort may be made to assign group of consecutive AAs to each DEFS. Initially, the distribution of storage space represented by the AAs assigned to each type of DEFS (e.g., data versus log) may be equal or roughly equal. Over time, based on differences in storage consumption by associated workloads, for example, due to differing write patterns, ownership of AAs may be transferred among the DEFSs accordingly.

As a result, of creating and distributing the disaggregated storage across a cluster in this manner, all disks and all RAID groups can theoretically be accessed concurrently by all nodes and the issue discussed with reference to FIG. 5 in which the entirety of any given disk and the entirety of any given RAID group is owned by a single node is avoided.

### Overview Regarding Disaggregated Storage System Workflows

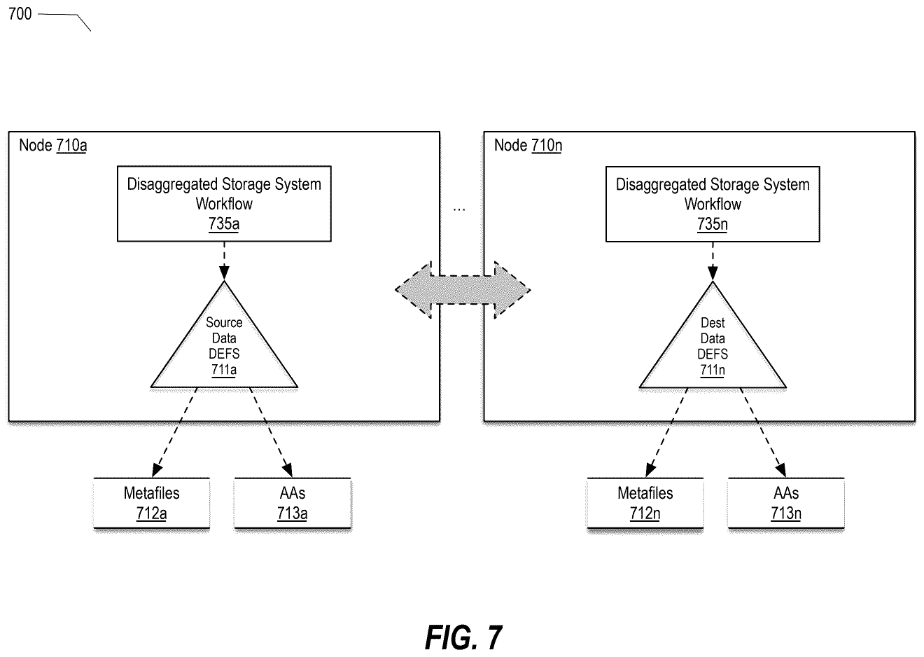

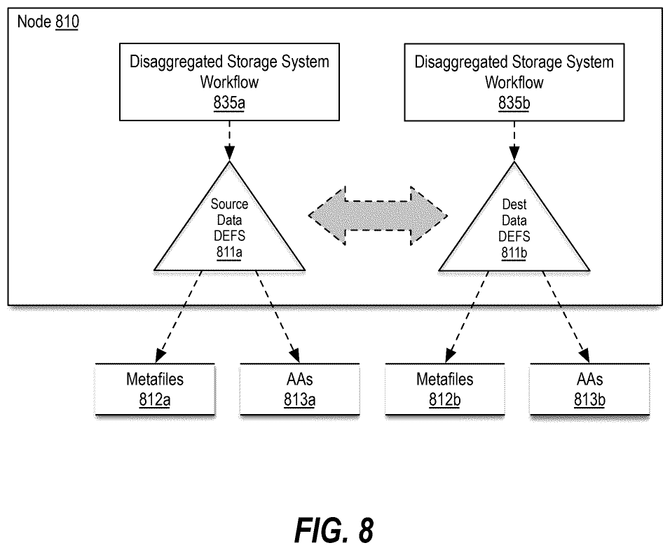

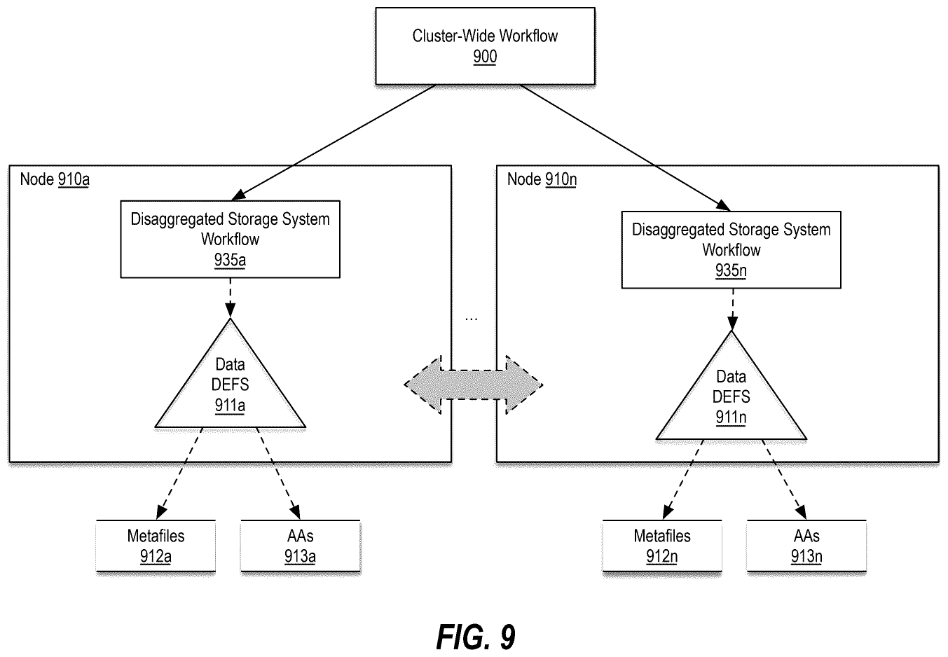

As noted above, in a disaggregated storage system, such as that described with reference to FIG. 6A, that make use of disaggregated storage space, ownership of AAs and associated metadata information (e.g., bitmaps, such an active map metafile, for example, active map 611a or 611b, and the like) by a particular DEFS of the cluster limits write access to PVBNs of the AAs and access to the associated metadata information to the particular DEFS. Given these access limitations, in various embodiments described herein, a disaggregated workflow operating on one DEFS (a source DEFS) may make use of information indicative of, among other things, AA ownership and may need to interact with another disaggregated workflow associated with a different DEFS (a destination DEFS) to perform certain tasks on its behalf as shown and described with reference to FIGS. 7-8. In other examples, high-level workflows (e.g., cluster-wide workflows, such as file system consistency checking, RAID reconstruction, etc.) may be broken down into sub-workflows (which may be referred to herein as “sibling” or “corresponding” disaggregated storage system workflows) as shown and described with reference to FIG. 9.

FIG. 7 is a block diagram conceptually illustrating an example of disaggregated storage system workflows (e.g., disaggregated storage system workflows 735a-n) involving a source DEFS (e.g., source data DEFS 711a) and a destination DEFS (e.g., destination data DEFS 711n) in accordance with an embodiment of the present disclosure. In the context of the present example, multiple nodes (e.g., nodes 710a-n) of a cluster 700 represent a distributed storage system. Disaggregated storage system workflow 735a and source data DEFS 711a are operable on node 710a (which may be analogous to node 610a) and disaggregated storage system workflow 735n and destination data DEFS 711n are operable on node 710n (which may be analogous to node 610b). The source data DEFS 711a and destination DEFS 711n may be analogous to data DEFSs 620a-b.

In the context of the present example, AAs 713a may represent those AAs owned by the source DEFS 711a and metafiles 712a may represent metadata information associated with the AAs 713a (or PVBNs thereof), which may also be said to be owned by the source DEFS 711a. Similarly, AAs 713n may represent those AAs owned by the destination DEFS 711n and metafiles 712n may represent metadata information associated with the AAs 713n (or PVBNs thereof), which may also be said to be owned by the destination DEFS 711n.

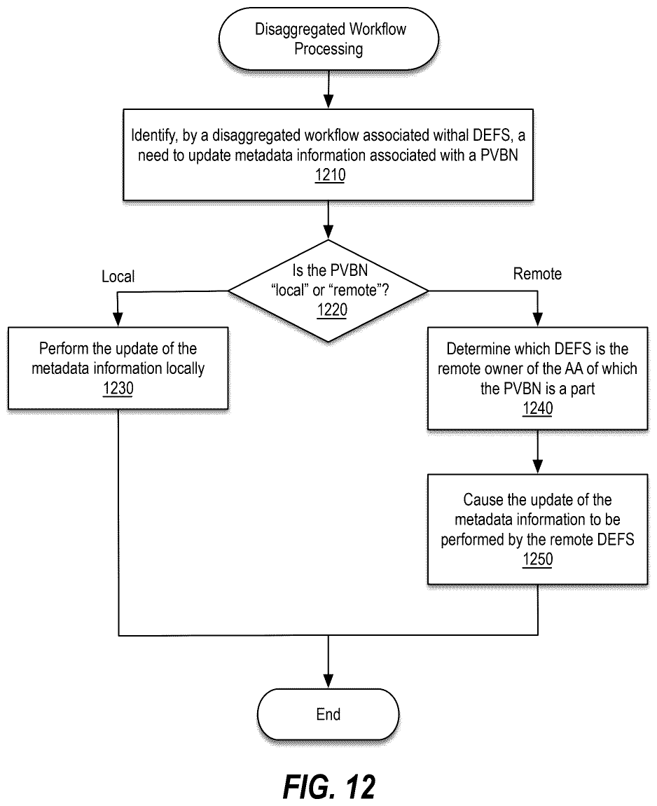

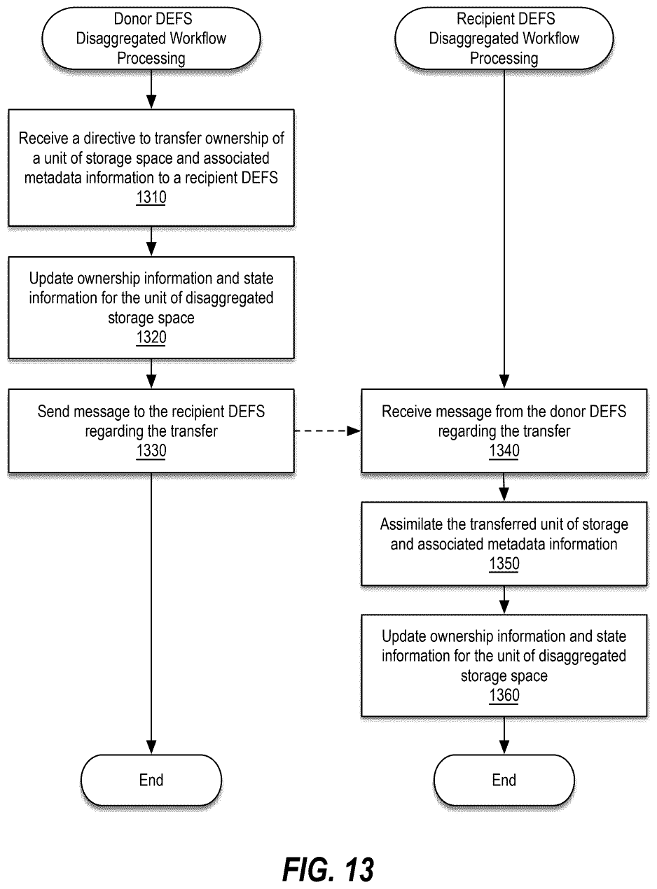

As noted above, in some examples, a disaggregated storage system workflow operating on one DEFS (the source DEFS, which may also be referred to as a local DEFS or a donor DEFS depending on the particular context) may need to interact with another disaggregated workflow associated with a different DEFS (the destination DEFS, which may also be referred to as a remote DEFS or a recipient DEFS depending on the particular context) to perform certain tasks (e.g., update of metadata information for a remote PVBN of an AA the local DEFS does or does not own) on its behalf and/or may transmit one or more messages (e.g., relating to AA movement) to the destination DEFS. Non-limiting examples of disaggregated storage system workflows operating in this manner include block free (or PVBN refcount decrement) and AA movement workflows, which are described below with reference to FIGS. 12 and 13, respectively.

FIG. 8 is a block diagram conceptually illustrating another example of disaggregated storage system workflows (e.g., disaggregated storage system workflows 835a-n) involving a source DEFS (e.g., source data DEFS 811a) and a destination DEFS (e.g., destination data DEFS 811b) in accordance with an embodiment of the present disclosure. In this example, the two interacting disaggregated storage system workflows 835a-b and the corresponding source data DEFS 811a and destination data DEFS 811b are operable on the same node 810 (which may be analogous to one of nodes 610a-b). The source data DEFS 811a and destination DEFS 811b may be analogous to data DEFSs 620a-b except they reside on or are hosted by the same node. In the context of the present example, AAs 813a may represent those AAs owned by the source DEFS 811a and metafiles 812a may represent metadata information associated with the AAs 813a (or PVBNs thereof), which may also be said to be owned by the source DEFS 811a. Similarly, AAs 813b may represent those AAs owned by the destination DEFS 811b and metafiles 812b may represent metadata information associated with the AAs 813b (or PVBNs thereof), which may also be said to be owned by the destination DEFS 811b.

As noted above, with reference to FIG. 7, in some examples, a disaggregated storage system workflow operating on one DEFS (the source DEFS, which may also be referred to as a local DEFS or a donor DEFS depending on the particular context) may need to interact with another disaggregated workflow associated with a different DEFS (the destination DEFS, which may also be referred to as a remote DEFS or a recipient DEFS depending on the particular context) to perform certain tasks (e.g., update of metadata information for a remote PVBN of an AA the local DEFS does or does not own) on its behalf and/or may transmit one or more messages (e.g., relating to AA movement) to the destination DEFS. The present example is presented to make it clear that a destination (or remote) DEFS may be considered “remote” from a source (or local) DEFS regardless of being hosted on the same node as the source (or local) DEFS. From the perspective of a disaggregated workflow (e.g., disaggregated storage system workflow 835a) operable on the source DEFS (e.g., source data DEFS 811a), the source DEFS is considered the local DEFS and the destination DEFS (e.g., destination data DEFS 811b) is considered a remote DEFS.

FIG. 9 is a block diagram conceptually illustrating an example of sibling or corresponding disaggregated storage system workflows (e.g., disaggregated storage system workflows 935a and 935n) triggered by a cluster-wide workflow (e.g., workflow 900) in accordance with an embodiment of the present disclosure. In this example, disaggregated storage system workflow 935a and data DEFS 911a are operable on node 910a (which may be analogous to node 610a) and disaggregated storage system workflow 935n and data DEFS 911n are operable on node 910n (which may be analogous to node 610b). Data DEFS 911a and data DEFS 911n may be analogous to data DEFSs 620a-b. In the context of the present example, AAs 913a may represent those AAs owned by the data DEFS 911a and metafiles 912a may represent metadata information associated with the AAs 913a (or PVBNs thereof, which may also be said to be owned by data DEFS 911a. Similarly, AAs 913n may represent those AAs owned by data DEFS 911n and metafiles 912n may represent metadata information associated with the AAs 913n (or PVBNs thereof), which may also be said to be owned by data DEFS 911n.

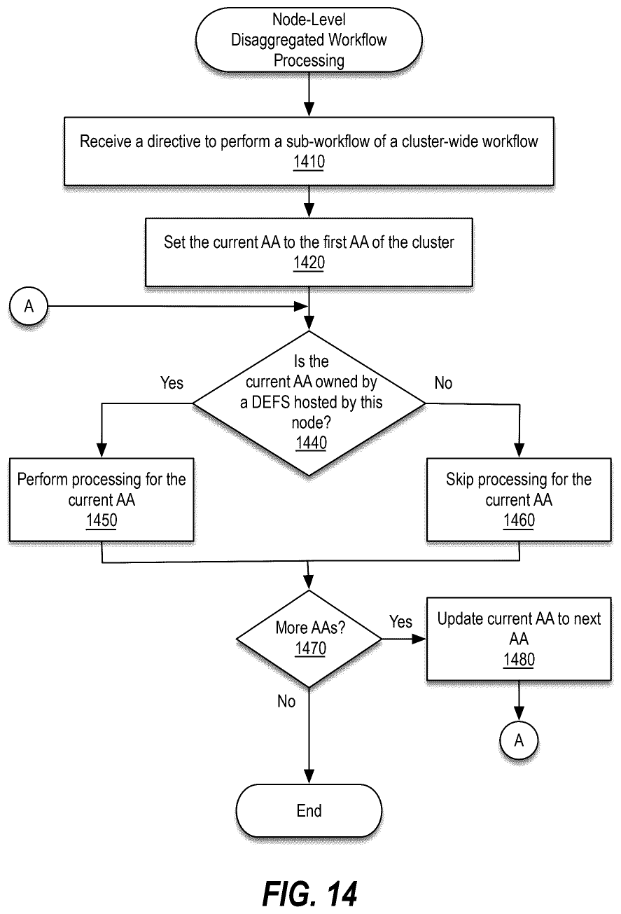

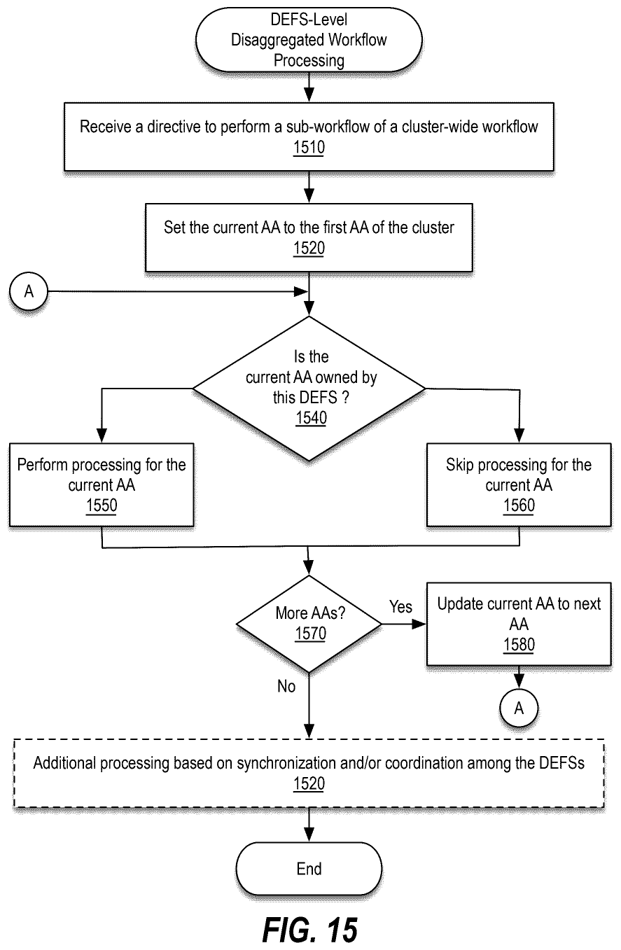

In the context of the present example, the cluster-wide workflow (e.g., a file system consistency check workflow, a RAID reconstruction workflow, etc.) is essentially broken down into sub-workflows (which may be referred to herein as “sibling” or “corresponding” disaggregated storage system workflows) that may be activated or triggered by the cluster-wide workflow. As described further below, the individual sibling distributed storage system workflows may be operable on a given DEFS (a DEFS-level disaggregated workflow) or operable on a given node (a node-level disaggregated workflow) to perform appropriate processing or tasks with respect to AAs owned by the given DEFS or DEFSs of the node at issue and/or metadata information associated therewith. Non-limiting examples of a node-level disaggregated workflow and a DEFS-level workflow following the general pattern of operation described in connection with FIG. 9 are described further below with reference to FIGS. 14 and 15, respectively.

### Example Cluster and AA Ownership Information

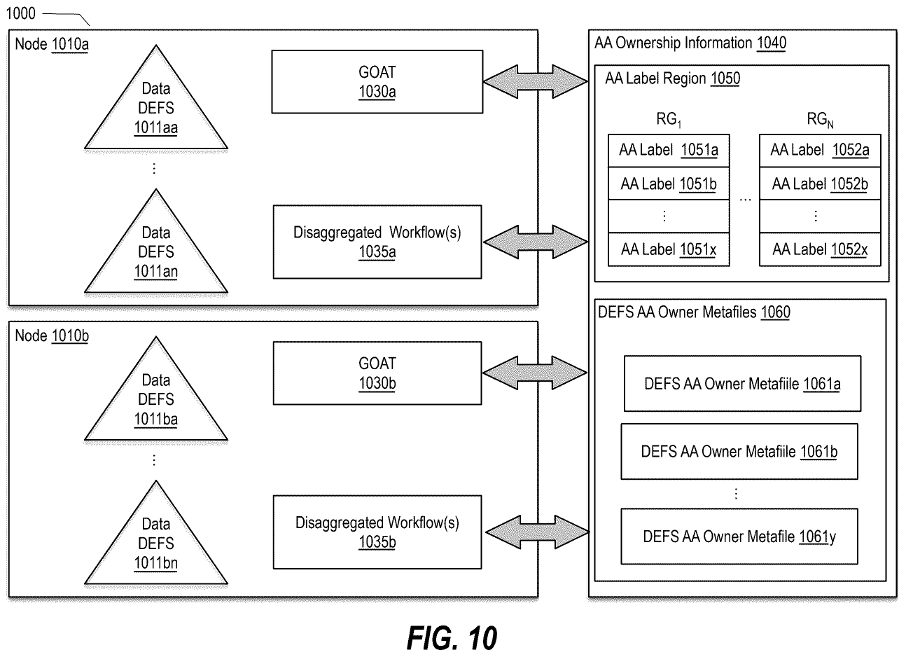

FIG. 10 is a block diagram 1000 conceptually illustrating nodes (e.g., nodes 1010a and 1010b) of a cluster (comprising nodes 1010a and 1010b) and AA ownership information 1040 in accordance with an embodiment of the present disclosure.

In the context of the present example, each node is shown having respective data DEFSs (e.g., data DEFSs 1011aa-an and data DEFSs 1011ba-bn), which may be analogous to data DEFSs 620a and 620b. Each node also includes respective GOATs (e.g., GOATs 1030a-b) and respective disaggregated workflow(s) (e.g., disaggregated workflow(s) 1035a-b), which may be analogous to disaggregated storage system workflows 735a-n, 835a-b, or 935a-n.

In this example, AA ownership information 1040 relating to the AAs assigned to/owned by the respective data DEFSs is maintained within two different on-disk data sources, including an AA label region 1050 and DEFS AA owner metafiles 1060. According to one embodiment, the AA label region 1050 is cluster scoped and there is one AA label region per cluster. In the context of the present example, AAs are RAID group (RG) scoped and a given AA ID may be reused for multiple RGs. As such, a combination of both the RG ID and the AA ID would be used in this example, to uniquely identify a given AA label (e.g., one of AA labels 1051a-x of RG₁ or one of AA labels 1052a-x of RGN), which contains, among other information, information identifying the current owner (i.e., the DEFS that currently owns the associated AA) and the proposed owner (i.e., the DEFS to which the associated AA is being reassigned, for example, during a space balancing operation moving the associated AA from the current owner (the donor DEFS) to the proposed owner (the recipient DEFS)).

In one embodiment, every disk (e.g., data and parity) in an RG is divided into various regions or zones, including a file system region, a RAID area, etc. Each region can be either fixed or variable sized. Each zone's starting disk block number (DBN) may be recorded in a table of contents (TOC) of the disk. According to one embodiment, AA label region 1050 is located outside of the file system region and each AA label includes 4 blocks (e.g., four 4 KB blocks) per AA on the data and parity disks. Generally, only one of the replicated AA labels, which are written to the same DBN (e.g., the same stripe) on each disk, is used and the others are for redundancy in case of a disk failure or block corruption

According to one embodiment, the DEFS AA owner metafiles 1060 are DEFS scoped and each contain information regarding those AAs owned by the associated DEFS. For example, the DEFS AA owner metafile (e.g., one of DEFS AA owner metafiles 1061a-y) for data DEFS 1011aa may include an AA bitmap with a corresponding bit set for each AA ID that is owned by data DEFS 1011aa. In this example, the individual DEFS AA owner metafiles only identify AAs owned by the corresponding DEFS and do not provide information regarding the owning DEFS for those AAs not owned by the corresponding DEFS.

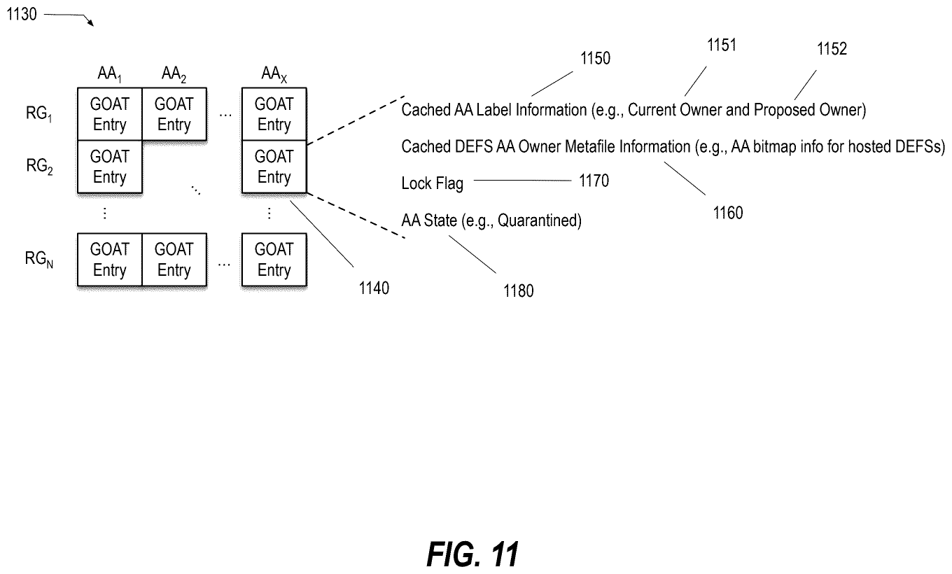

In the context of the present example, the GOATs 1030a and 1030b are node scoped. The GOAT of a given node caches the AA ownership information 1040 in-memory for all DEFSs hosted by the given node. In one embodiment, a periodic (e.g., every X minutes) GOAT refresh is performed to update the cached AA ownership information that may have changed as a result of AA movement from one DEFS to another. Depending on the particular implementation, local disaggregated workflows (e.g., remote freeing of blocks (or remote decrementing of PVBN reference counts), remote reference count incrementing, AA movement, AA ownership consistency checking, RAID reconstruction, and file system consistency checking) associated with a given node may make use of the local GOAT associated with the given node rather than directly accessing the AA ownership information 1040 from persistent storage. In some embodiments, one or more disaggregated workflows may update the AA ownership information 1040 directly by obtaining a lock on the AA label at issue and may also make corresponding updates to the local GOAT. Brief descriptions regarding how GOAT may be used by various non-limiting examples of representative disaggregated workflows of disaggregated storage system consumers (e.g., subsystems of the storage system node or of the local DEFS) are provided below. A non-limiting example of a GOAT is described further below with reference to FIG. 11.

### Example Global Ownership of AAs Table (GOAT)

FIG. 11 is a block diagram conceptually illustrating a global ownership of AAs table (GOAT) 1130 in accordance with an embodiment of the present disclosure. GOAT 1130 may be analogous to GOATs 1030a and 1030b of FIG. 10.

According to one embodiment, GOAT 1130 serves one or more of the following purposes:
Acts as a multiprocessing (MP)-safe cache for the information in the DEFS AA owner metafiles (e.g., DEFS AA owner metafiles 1044) across all DEFSs hosted on a given node.
Acts as an MP-safe cache for the information in the AA label region (e.g., AA label region 1050).
This cache of information in the AA label region may be used to propagate AA ownership changes across the cluster.
Acts as a mechanism to coordinate between AA movement and other subsystems that need to know whether an AA and/or an associated PVBN is “local” or “remote” (e.g., owned by the local DEFS or a remote DEFS, whether on the same node or a remote node within the cluster).
Acts as a mechanism to prevent movement of a given AA and/or control access to associated metadata information, for example, until an AA in the process of being moved from a donor DEFS (e.g., source data DEFS 711a or 811a) to a recipient DEFS (e.g., destination DEFs 711n or 811n) has been assimilated by the recipient DEFS.
Acts as a mechanism to serialize access and Input/Output (IO) operations to the AA label region.

In the context of the present example, the GOAT 1130 may be represented as a flat array indexed by RG ID and AA ID to uniquely identify a GOAT entry (e.g., GOAT entry 1140) corresponding to a given AA. In one embodiment, the flat array may include an array of RG IDs in which each RD ID entry of the array of RG IDs is further associated with an array of AA IDs each associated with a corresponding GOAT entry. In this example, each GOAT entry may include, among other information, cached AA label information 1150 (e.g., a current owner 1150 of the given AA and a proposed owner 1152 of the given AA), cached DEFS AA owner metafile information 1160, for example, at least a portion (e.g., a bit or a flag indicative of ownership) of an AA bitmap (e.g., AA map 622a or 622b) corresponding to the AA at issue for each DEFS hosted by the node, a lock flag 1170 (e.g., that may be used to serialize access to the underlying persistent version of the corresponding AA label), and AA state information 1180 (e.g., indicative of whether or not the AA is quarantined-indicating access to the AA and associated metadata information is temporarily restricted or blocked, for example, awaiting completion of assimilation of this AA, which is in the process on being moved, by the recipient DEFS). As those skilled in the art will appreciate, various cache coherence mechanisms may be used to mark information in a given GOAT entry as stale (e.g., a sequence number or a generation number), for example, in the case of a takeover (e.g., a failover from a primary node of an HA cluster to a secondary node of the HA cluster).

According to one embodiment, the cached AA label information 1150 within a given GOAT entry (e.g., GOAT entry 1140) includes a current owner field (e.g., current owner 1151) and a proposed owner field (e.g., proposed owner 1152). When these fields are equal, then the DEFS ID contained in either field corresponds to the DEFS of the cluster that is the current owner of the AA at issue. These fields may also be used to indicate the AA at issue is in transition (i.e., in the process of being moved from the DEFS identified by the DEFS ID specified by the current owner field to the DEFS identified by the DEFS ID specified by the proposed owner field). For example, as described further below, these fields may be updated during AA movement, including the donor DEFS updating the proposed owner to the DEFS ID of the recipient DEFS prior to AA movement and the recipient DEFS updating the current owner to the DEFS ID of the recipient DEFS after AA movement has been completed (e.g., after assimilation of the AA at issue and its associated metadata information by the recipient DEFS).

As noted above, in support of space balancing AAs may be reassigned or moved from one DEFS (the donor DEFS) to another DEFS (the recipient DEFS), for example, by changing ownership information associated with the AAs at issue. Depending on the particular implementation of AA movement, the associated AA ownership change and movement of associated metadata information (e.g., metafiles associated with the PVBNs of the AAs at issue) may span multiple CPs. Therefore, while movement of a given AA is in process, the current owner 1151 of the AA and the proposed owner 1152 of the AA will specify different DEFS IDs. When AA movement has been completed or no AA movement has taken place for a given AA, the current owner 1151 and the proposed owner 1152 for the given AA will specify the same DEFS ID.

### Example GOAT Refresh

In some cases, the GOAT entries of a given GOAT may become out of date or stale. For example, consider a four-node cluster in which an AA is moved from a donor DEFS on a first node to a recipient DEFS on a second node. In this example, the GOATs of the first and second node are updated as part of the AA movement process; however, the GOATs of the nodes (i.e., the third node and the fourth node) not involved in the AA movement are not updated as part of the AA movement process. As such, in various embodiments, a GOAT refresh may be periodically performed (e.g., every minute or every couple minutes) to read the AA label region 1042 and metadata information (e.g., the DEFS AA owner metafiles 1044) into local memory (the GOAT) of each node. Notably, as in some examples, the donor and recipient DEFS of an AA movement may be on the same node, a GOAT of a two-node cluster may also become out of date or stale.

### Example Disaggregated Workflows

FIG. 12 is a high-level flow diagram illustrating operations for performing a disaggregated workflow associated with a DEFS in accordance with an embodiment of the present disclosure. The processing described with reference to FIG. 12 may be performed by a disaggregated workflow (e.g., one of disaggregated storage system workflows 735a or 835a) running within a DEFS (e.g., one of source data DEFSs 711a or 811a) or a disaggregated workflow (e.g., one or disaggregated workflow(s) 1035a or one or disaggregated workflow(s) 1035) otherwise associated with one or more DEFS (e.g., data DEFSs 1011aa-an or data DEFSs 1011ba-bn).

At block 1210, the disaggregated workflow identifies a need to update metadata information associated with a PVBN. For example, this situation may arise in connection with a copy-on-write file system (e.g., the WAFL® file system) in which old PVBNs may be freed because the file system does not write in place, but rather writes to new blocks. Another situation in which metadata information associated with a PVBN may need to be updated includes the reuse of a PVBN (e.g., as part of deduplication). In this case, the storage operating system may be seeking to perform an increment of a reference count associated with the reused PVBN.

At decision block 1220, it is determined whether the PVBN is local or remote.

As noted above, in one embodiment, a given PVBN (and its associated metadata information) is considered to be local when the DEFS (the local DEFS) for which or on which the distributed workflow is being performed owns the AA of which the given PVBN is a part. Otherwise, the given PVBN (and its associated metadata information) is considered to be remote. In the context of the present example, when the PVBN is local, processing continues with block 1230. When the PVBN is remote, processing branches to block 1240. According to one embodiment, the determination regarding whether a given PVBN is local or remote may be made with reference to an AA ownership information (e.g., AA ownership information 1040) cached within a memory of the node on which the DEFS resides. The disaggregated workflow may first check cached DEFS AA owner metadata information (e.g., cached DEFS AA owner metafile information 1160) of the corresponding GOAT entry (e.g., GOAT entry 1140) of the local GOAT (e.g., GOAT 1030a or 1130), which may be determined by mathematically deriving the corresponding RG and AA IDs based on, among other things, a known size of AAs (or number of PVBNS associated with AAs). In one embodiment, the PVBN is considered local if the portion of an AA bitmap (e.g., AA map 622a or 622b) within the cached DEFS AA owner metafile information indicates the local DEFS owns the AA corresponding to the derived RG ID and AA ID; otherwise, the PVBN is considered remote.

At block 1230, the update of the metadata information may be performed locally. For example, a local PVBN metadata information update path may be used.

At block 1240, it is further determined which DEFS of the other DEFSs within the cluster is the remote owner of the AA (e.g., one of AAs 713a or 813a) of which the PVBN is a part. In one embodiment, this determination may be performed based on cached AA label information (e.g., cached AA label information 1150) of the corresponding GOAT entry. For example, as noted above, when a DEFS ID specified by a current owner field (e.g., current owner 1151) of the cached AA label information is the same as the DEFS ID specified by a proposed owner field (e.g., proposed owner 1152) of the cached AA label information, then the DEFS corresponding to that DEFS ID is the owner of the AA; and, in this case, identifies the remote DEFS owner of the AA. However, when the DEFS ID specified by the current owner field and the DEFS ID specified by the proposed owner field do not match, then the AA is in transition (in the process of being moved from the DEFS identified by the DEFS ID specified by the current owner field to the DEFS identified by the DEFS ID specified by the proposed owner field). In one embodiment, it is assumed this movement of the AA will be successful and the remote DEFS owner is deemed to be the DEFS specified by the proposed owner field.

At block 1240, the update of the metadata information is caused to be performed remotely. For example, the disaggregated workflow may place the PVBN (potentially batched with others) on a remote PVBN metadata information update path associated with the remote DEFS owner, for example, by using an internode communication mechanism (e.g., a persistent message queue).

While in the context of the present example, a need is identified by a disaggregated workflow to update metadata information associated with a particular PVBN, it is to be appreciated, in other examples, the metadata information may alternatively be associated with a particular AA. The above-described disaggregated workflow is described in terms of a generalized approach for updating metadata information associated with a particular PVBN. The application of the above-described disaggregated workflow specifically to block free is described further below.

### Block Free (Blkfree)

DEFSs own respective sets of AAs from which PVBNs are write allocated (allocated for performing writes) to persist modified data to disk. This allocation of PVBNs for performing writes may also be referred to herein as “write allocation.” Since an AA may move from one DEFS to another, for example, as a result of performing space balancing operations, it is possible that some PVBNs which appear in a user file's bufftree residing in a given volume contained in a given DEFS (e.g., DEFS1) were write allocated from an AA which was owned by DEFS1 in the past but has since been moved to DEFS2 (e.g., for space balancing reasons). In such cases, when the client overwrites or frees such a PVBN, the storage operating system needs to know that the PVBN is currently owned by DEFS2 so it can properly manipulate the various associated bitmap file(s)′ (e.g., active map metafile, refcount metafile) region corresponding to that PVBN appropriately to record a block free. In various embodiments described herein, only the DEFS that currently owns the AA is allowed to manipulate the bitmap file regions corresponding to that AA. In the example above, the block free will be transmitted from DEFS1 to DEFS2, for example, using an internode communication mechanism (e.g., a persistent message queue). Depending on the particular implementation, such remote block frees may be batched for communication efficiency. In one embodiment, GOAT (e.g., one of GOATs 1030a-b or GOAT 1130) is the mechanism through which the free pipeline knows whether a given PVBN belongs to a “local” DEFS or a “remote” DEFS and consequently whether the block free should be performed locally or remotely.

In examples described herein, old PVBNs may be freed because the file system does not write in place, but rather writes to new blocks. In one embodiment, the block free or PVBN refcount decrement process includes the following steps:
First, determine whether the PVBN at issue is local vs. remote. As noted above with reference to FIG. 12, this may involve checking the DEFS AA owner metafile information (e.g., cached DEFS AA owner metafile information 1160) of the DEFS that is attempting to perform the PVBN free.
If the PVBN at issue is local, the local PVBN free path is used.
If the PVBN at issue is remote, the remote PVBN free path is used.
   Determine which DEFS is the remote owner (based on GOAT).
   For example, as noted above with reference to FIG. 12, the remote owner DEFS may be determined by examining the current owner (e.g., current owner 1151) and the proposed owner (e.g., proposed owner 1152) fields of cached AA label information (e.g., cached AA label information 1150) within a GOAT entry (e.g., GOAT entry 1140) corresponding to the AA of which the PVBN is a part. If the current owner and the proposed owner are different, then the AA of which this PVBN is a part is in the process of being moved from the current owner (the donor DEFS) to the proposed owner (the recipient DEFS). According to one embodiment, an assumption is that the AA movement will succeed, so the remote PVBN free path is used, which may include sending a message to the DEFS (the soon to be remote DEFS owner) corresponding to the DEFS ID specified by the proposed owner. Otherwise, if the current owner and the proposed owner are the same DEFS ID, then the DEFS corresponding to that DEFS ID is the remote DEFS owner and the remote PVBN free path is used., which may include sending a message to the remote DEFS owner.
Remote RefCnt Increment

The generalized disaggregated workflow described with reference to FIG. 12 is also applicable to performing local or remote refcnt increment. In this case, the storage operating system is seeking to perform a reference count increment of a PVBN that is being reused (e.g., as part of deduplication). That is, rather than storing duplicate data, a reference to another PVBN that already contains the data at issue is stored. In one embodiment, this is a similar use case as above. That is, the storage operating system determines to which DEFS to send this “refcount increment” request as opposed to “block free” request.

FIG. 13 is a high-level flow diagram illustrating operations for performing donor-recipient disaggregated workflows in accordance with an embodiment of the present disclosure. The processing described with reference to FIG. 13 may be performed by a disaggregated workflow (e.g., one of disaggregated storage system workflows 735a or 835a) running within a DEFS (e.g., one of source data DEFSs 711a or 811a) or a disaggregated workflow (e.g., one or disaggregated workflow(s) 1035a or one or disaggregated workflow(s) 1035) otherwise associated with one or more DEFS (e.g., data DEFSs 1011aa-an or data DEFSs 1011ba-bn).

At block 1310, a donor DEFS receives a directive to transfer ownership of a unit of storage space (e.g., an AA) and associated metadata information to a recipient DEFS. This directive may be received from another subsystem of the distributed storage system, for example, that is responsible for, among other things, monitoring storage space usage by all DEFSs of the cluster, identifying the donor and recipient DEFSs, and specifying the number and quality of AAs to be transferred from the donor DEFS to the recipient DEFS. As the present disclosure is focused on the use and maintenance of persistent AA ownership information (e.g., AA ownership information 1040) and an in-memory cache of AA ownership information (e.g., GOAT 1030a or GOAT 1030b) within the nodes of the cluster to facilitate performance of various types of disaggregated workflows, various specific details (e.g., relating to, among other things, how AAs are transferred between DEFSs and how DEFSs message each other) are intentionally omitted herein as they are not necessary for understanding the use or maintenance of the AA ownership information.

At block 1320, ownership information and state information for the unit of disaggregated storage space is updated. According to one embodiment, the AA(s) at issue may be removed from the AA map (e.g., AA map 622a) of the source DEFS and both cached and persistent AA label information may be updated as appropriate. For example, a proposed owner field (e.g., proposed owner 1152) may be set to the DEFS ID of the recipient DEFS.

At block 1330, a message may be sent to the recipient DEFS regarding the transfer. This message may be sent, for example, using an internode communication mechanism (e.g., a persistent message queue).

At block 1340, the recipient DEFS receives the message from the donor DEFS relating to the transfer of storage space and associated metadata information.

At block 1350, the storage space of the recipient DEFS is increased by assimilating the transferred unit of storage and associated metadata information.

At block 1360, as the movement operation has now been completed and is no longer in process, ownership information and state information for the unit of disaggregated storage space are updated. According to one embodiment, the AA(s) at issue may be added to the AA map (e.g., AA map 622b) of the recipient DEFS and both cached and persistent AA label information may be updated as appropriate. For example, a current owner field (e.g., proposed owner 1151) may be set to the DEFS ID of the recipient DEFS.

Additional details regarding the application of the above-described donor-recipient disaggregated workflows in connection with performing AA movement are provided below.

### AA Movement

Depending on the particular implementation, the AA movement process both on the source side (e.g., the donor DEFS) and the destination side (e.g., the recipient DEFS) may be a complicated multi-step process which can span multiple CPs and involves manipulating the GOAT entry, AA label region, metafiles corresponding to the AA being moved and doing the actual transfer from the donor DEFS to the recipient DEFS on disk. While not necessary for understanding the implementation and use of GOAT and AA labels, further explanation regarding space balancing and AA ownership change is provided in co-pending U.S. patent application Ser. No. 19/068,324 and co-pending U.S. patent application Ser. No. 18/595,785, filed on Mar. 5, 2024, both of which are hereby incorporated by reference in their entirety for all purposes.

During AA movement, the GOAT (e.g., GOAT 1030a or 1030b) may act as an indication for all other consumers that this AA has begun the process of being moved and starts coordinating and clamping down access to the AA. For example, AA labels are written on disk to note the current owner as the DEFS ID of the donor DEFS and the proposed owner as the DEFS ID of the recipient DEFS.

As noted above, each PVBN has associated metadata. The GOAT may help manage access to metafiles associated with the PVBNs (e.g., active map metafile, refcount metafile, etc.). For example, when moving an AA, the metadata information associated with the PVBNs of the AA may also be moved to the recipient DEFS.

In some examples, the metafiles accessible to a given DEFS only contain information for AAs that are owned by the given DEFS. While performing an AA movement (e.g., from a donor DEFS to a recipient DEFS), access to the metadata information should not be changed until the AA and metadata information are assimilated by the recipient DEFS. As such, in one embodiment, the metadata information is locked down, for example, by adding state information to GOAT (e.g., marking the AA as “quarantined”) until the AA is assimilated by the recipient DEFS. GOAT therefore coordinates access to AAs, for example, by restricting access to AAs that are in the process of being moved and permitting access to AAs after the assimilation of moved AAs has been complete.

In some examples, the donor and recipient DEFSs (or AA movement handlers associated with the donor and recipient DEFSs) update the AA label (e.g., by taking a lock (e.g., lock flag 1170) on the corresponding GOAT entry (e.g., GOAT entry 1140) to fence the entry) to serialize access.

FIG. 14 is a high-level flow diagram illustrating operations for performing a cluster-wide workflow involving multiple node-level disaggregated workflows in accordance with an embodiment of the present disclosure. The processing described with reference to FIG. 14 may be performed by one of the multiple node-level disaggregated workflows (e.g., one of disaggregated storage system workflows 935a-n) running on one or more nodes (e.g., node 910a-n) of a cluster representing a distributed storage system.

At block 1410, a node-level disaggregated workflow (e.g., disaggregated storage system workflow 935a) operable on a particular node (e.g., node 910a) of the cluster receives a directive to perform a sub-workflow of a cluster-wide workflow (e.g., cluster-wide workflow 900). A non-limiting example of a cluster-wide workflow for which processing may be distributed over all nodes of a cluster is RAID reconstruction.

Blocks 1420-1470 generally relate to iterating through each AA of the cluster and performing relevant processing for the AA relating to the nature of the cluster-wide workflow at issue. In view of the fact that particular embodiments distribute AAs across multiple DEFSs of a cluster that may be hosted by (or resident on) respective nodes of the cluster, cluster-wide processing that is to be performed on all AAs of the cluster, for example, should generally be distributed across all nodes of the cluster and each node should only operate on those of the AAs owned by a DEFS hosted by (or resident on) that node.

At block 1420, a current AA iterator is set to the first AA of the cluster. For example, the current AA may be set to the AA ID associated with first AA of the cluster.

At decision block 1440, a determination is made regarding whether the current AA is owned by a DEFS that is hosted by (or resident on) the particular node. If so, then processing continues with block 1450; otherwise, processing branches to block 1460. In one embodiment, the set of one or more DEFS hosted by (or resident on) the particular node may be identified, for example, by looping through all DEFS labels and comparing a node ID contained therein to the node ID of the particular node. The determination relating to a given AA being owned by one of these hosted DEFSs may then be performed based on the AA bitmaps (e.g., AA map 622a or 622b) within cached AA owner metafile information (e.g., cached DEFS AA owner metafile information 1150) within an in-memory cache of AA ownership information (e.g., GOAT 1030a or GOAT 1030b) on the particular node.

At block 1450, appropriate processing is performed for the current AA by the node-level disaggregated workflow depending on the cluster-wide workflow at issue.

At block 1460, processing for the current AA is skipped as the current AA is not owned by a DEFS hosted by (or resident on) the particular node.

At decision block 1470, it is determined whether there are one or more additional AAs are to be considered. If so, processing continues with block 1480; otherwise, the node-level disaggregated workflow processing is complete.

At block 1480, the current AA iterator is updated to the next AA. For example, the current AA is set to the AA ID of the next AA.

While in the context of the present example, a single node-level disaggregated workflow is described, it is to be appreciated the same process may be performed by one or more other node-level disaggregated workflows operable on other nodes of the cluster.

Additional details regarding the application of the above-described node-level disaggregated workflow in connection with performing RAID reconstruction is provided below.

### RAID Reconstruction

RAID reconstruction is the process of reconstructing the data from a failed disk to a newly added spare disk. It is typically done to bring a degraded RG back to health. In some embodiments, all nodes in the cluster start reconstruction on the same disk in parallel to maximize the CPU bandwidth to complete the process. During the process of reconstruction, the RAID subsystem consults GOAT to determine AA ownership. A node is only allowed to reconstruct AAs which one of its resident DEFSs owns. The general process is given an AA, map it to the “owner” DEFS, then check if the owner DEFS is resident on this node. If so, this node's RAID module is allowed to reconstruct the AA. This coordination ensures only one node writes to any given AA at a time as multiple concurrent writes to the same AA can result in inconsistent data. In one embodiment, reconstruction of the AA label also hooks into the file system reconstruction process. When the filesystem region for an AA is being reconstructed, the AA label module also reconstructs the AA label region for that AA.

FIG. 15 is a high-level flow diagram illustrating operations for performing a cluster-wide workflow involving multiple DEFS-level disaggregated workflows in accordance with an embodiment of the present disclosure. The processing described with reference to FIG. 15 may be performed by one of the multiple DEFS-level disaggregated workflows (e.g., one of disaggregated storage system workflows 935a-n) associated with corresponding DEFSs (e.g., data DEFSs 911a-n) hosted by (or residing on) on respective nodes (e.g., node 910a-n) of a cluster representing a distributed storage system.

At block 1510, a DEFS-level disaggregated workflow (e.g., disaggregated storage system workflow 935a) associated with a particular DEFS (e.g., data DEFS 911a) receives a directive to perform a sub-workflow of a cluster-wide workflow (e.g., cluster-wide workflow 900). Non-limiting examples of a cluster-wide workflows for which processing may be distributed over multiple DEFSs include file system consistency checking and AA ownership consistency checking, which, depending on the particular implementation, may be performed together or independently.

Blocks 1520-1570 generally relate to iterating through each AA of the cluster and performing relevant processing for the AA relating to the nature of the cluster-wide workflow at issue. In view of the fact that particular embodiments distribute AAs across multiple DEFSs of a cluster, cluster-wide processing that is to be performed on all AAs of the cluster, for example, should generally be distributed across all DEFSs of the cluster and a given DEFS should only operate on those of the AAs owned by the given DEFS.

At block 1520, a current AA iterator is set to the first AA of the cluster. For example, the current AA may be set to the AA ID associated with first AA of the cluster.

At decision block 1540, a determination is made regarding whether the current AA is owned by the particular DEFS. If so, then processing continues with block 1550; otherwise, processing branches to block 1560. According to one embodiment, the determination relating to a given AA being owned by the particular DEFS may be performed based on an AA bitmap (e.g., AA map 622a or 622b) within cached AA owner metafile information (e.g., cached DEFS AA owner metafile information 1150) within an in-memory cache of AA ownership information (e.g., GOAT 1030a or GOAT 1030b) on the node (e.g., node 910a) on which the DEFS-level workflow is operating.

At block 1550, appropriate processing is performed for the current AA by the DEFS-level disaggregated workflow depending on the cluster-wide workflow at issue.

At block 1560, processing for the current AA is skipped as the current AA is not owned by the particular DEFS.

At decision block 1570, it is determined whether there are one or more additional AAs are to be considered. If so, processing continues with block 1580; otherwise, the DEFS-level disaggregated workflow processing is complete.

At block 1580, the current AA iterator is updated to the next AA. For example, the current AA is set to the AA ID of the next AA.

While in the context of the flow diagrams of FIGS. 6B and 12-15 a number of enumerated blocks are included, it is to be understood that examples may include additional blocks before, after, and/or in between the enumerated blocks. Similarly, in some examples, one or more of the enumerated blocks may be omitted and/or performed in a different order.

While in the context of the present example, a single DEFS-level disaggregated workflow is described, it is to be appreciated the same process may be performed by one or more other DEFS-level disaggregated workflows operable on the same and/or other nodes of the cluster. Additional details regarding the application of the above-described DEFS-level disaggregated workflow in connection with performing various other cluster-wide workflows is provided below.

### File System Consistency Checking and Correction

According to one embodiment, a file system consistency checking and correction workflow consults the current owner in the AA label region when trying to reconcile AA ownership to ensure that each AA is owned by exactly one DEFS and that all AAs are owned.

### Other Usage Scenarios Involving GOAT

### AA Ownership Consistency Checking

In various examples, DEFSs are allowed access only to the metadata information (e.g., bitmap metafile regions) corresponding to the AAs they own. They aren't supposed to access bitmap metafile regions corresponding to AAs that they don't own. GOAT (e.g., GOAT 1030a or 1030b) may play a role in managing this access since it contains a cache of each DEFS's AA owner metafile (e.g., DEFS AA owner metafiles 1060) and hence can intercept (e.g., via a file system hook) accesses to the metadata information and perform appropriate sanity check(s). In some embodiments, a consistency check may be performed every time an attempt is made to load or attempt to dirty a block from one of the metafiles (e.g., a DEFS accessing metadata information associated with a particular AA).

### Write Allocation Sanity Checking

According to one embodiment, each AA is supposed to be owned by one and exactly one DEFS at any given point of time. Each DEFS is only allowed to write allocate free PVBNs from AAs that it currently owns. In one example, GOAT and AA label act as a mechanism for a second layer of sanity checking in additional to the DEFS AA owner metafile to ensure that the given DEFS owns the AA. If, due to some bug, the DEFS AA owner metafiles for two different DEFSs indicate ownership of the same AA, due to the consistency checks done through GOAT and AA label, one of them will notice this disparity, mark the DEFS as inconsistent and force a file system consistency check to be run. In this manner, the distributed storage system can avoid inadvertently corrupting user data by allowing write allocation of the same free PVBNs from two different DEFSs.

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors (e.g., processors 222a-b) within a single computer) and storage systems containing or having network access to computer program(s) coded in accordance with various methods described herein, and the method steps associated with embodiments of the present disclosure may be accomplished by modules, routines, subroutines, or subparts of a computer program product.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device (e.g., local storage 230). Volatile media includes dynamic memory, such as main memory (e.g., memory 224). Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (e.g., system bus 223). Transmission media can also take the form of acoustic or light waves, such as those generated during radio-wave and infra-red data communications.

Various forms of media may be involved in carrying one or more sequences of one or more instructions to the one or more processors for execution. For example, the instructions may initially be carried on a magnetic disk or solid state drive of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector can receive the data carried in the infra-red signal and appropriate circuitry can place the data on bus. Bus carries the data to main memory (e.g., memory 224), from which the one or more processors retrieve and execute the instructions. The instructions received by main memory may optionally be stored on storage device either before or after execution by the one or more processors.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
maintaining, by a distributed storage system, an in-memory cache of allocation area (AA) ownership information on each node of a plurality of nodes of a cluster representing the distributed storage system relating to a respective set of one or more dynamically extensible file systems (DEFSs) of a plurality of DEFSs of the distributed storage system that are resident on the node; and
for each AA of a plurality of AAs, performing, by a node-level disaggregated workflow operable on a first node of the plurality of nodes, processing relating to the AA requested by a cluster-wide workflow based on the in-memory AA ownership cache on the first node indicating the AA is owned by one of the respective set of one or more DEFSs resident on the first node.

2. The method of claim 1, wherein performing the processing relating to the AA comprises skipping the processing for the AA when the AA is not owned by a DEFS of the respective set.

3. The method of claim 1, wherein the processing relating to the AA comprises Redundant Array of Independent (RAID) reconstruction.

4. The method of claim 1, wherein the in-memory cache of AA ownership information includes cached DEFS AA owner metafile information containing, for a given DEFS of the respective set, at least a portion of an AA bitmap indicative of those AAs of the plurality of AAs owned by the given DEFS.

5. The method of claim 4, further comprising determining, by the node-level disaggregated workflow, whether a given AA of the plurality of AAs is owned by a DEFS by evaluating the portion of the AA bitmap corresponding to the AA for each DEFS of the respective set.

6. The method of claim 1, wherein the in-memory cache of AA ownership information includes cached AA label information containing, for a given AA of a plurality of AAs, an AA label having (i) a current owner field containing a DEFS identifier (ID) identifying a first DEFS of the plurality of DEFSs that currently owns the given AA and (ii) a proposed owner field, which when ownership of the given AA is in transition contains a DEFS ID identifying a second DEFS of the plurality of DEFSs to which the ownership is to be transferred.

7. The method of claim 1, further comprising for each AA of the plurality of AAs, performing, by a node-level disaggregated workflow operable on a second node of the plurality of nodes, the processing relating to the AA requested by the cluster-wide workflow based on the in-memory AA ownership cache on the second node indicating the AA is owned by one of the respective set of one or more DEFSs resident on the second node.

8. A non-transitory machine readable medium storing instructions, which when executed by one or more processing resources of a distributed storage system, cause the distributed storage system to:
maintain an in-memory cache of allocation area (AA) ownership information on each node of a plurality of nodes of a cluster representing the distributed storage system relating to a respective set of one or more dynamically extensible file systems (DEFSs) of a plurality of DEFSs of the distributed storage system that are resident on the node; and
for each AA of a plurality of AAs, selectively perform, by a node-level disaggregated workflow operable on a first node of the plurality of nodes, processing relating to the AA requested by a cluster-wide workflow based on the in-memory AA ownership cache on the first node indicating the AA is owned by one of the respective set of one or more DEFSs resident on the first node.

9. The non-transitory machine readable medium of claim 8, wherein selectively performing the processing relating to the AA comprises skipping the processing for the AA when the AA is not owned by a DEFS of the respective set.

10. The non-transitory machine readable medium of claim 8, wherein the processing relating to the AA comprises Redundant Array of Independent (RAID) reconstruction.

11. The non-transitory machine readable medium of claim 8, wherein the in-memory cache of AA ownership information includes cached DEFS AA owner metafile information containing, for a given DEFS of the respective set, at least a portion of an AA bitmap indicative of those AAs of the plurality of AAs owned by the given DEFS.

12. The non-transitory machine readable medium of claim 11, wherein the instructions further cause the distributed storage system to determine whether a given AA of the plurality of AAs is owned by a DEFS by evaluating the portion of the AA bitmap corresponding to the AA for each DEFS of the respective set.

13. The non-transitory machine readable medium of claim 8, wherein the in-memory cache of AA ownership information includes cached AA label information containing, for a given AA of a plurality of AAs, an AA label having (i) a current owner field containing a DEFS identifier (ID) identifying a first DEFS of the plurality of DEFSs that currently owns the given AA and (ii) a proposed owner field, which when ownership of the given AA is in transition contains a DEFS ID identifying a second DEFS of the plurality of DEFSs to which the ownership is to be transferred.

14. The non-transitory machine readable medium of claim 8, wherein the instructions further cause the distributed storage system to, for each AA of the plurality of AAs, selectively perform, by a node-level disaggregated workflow operable on a second node of the plurality of nodes, the processing relating to the AA requested by the cluster-wide workflow based on the in-memory AA ownership cache on the second node indicating the AA is owned by one of the respective set of one or more DEFSs resident on the second node.

15. A distributed storage system comprising:
one or more processing resources; and
instructions that when executed by the one or more processing resources cause the distributed storage system to:
maintain an in-memory cache of allocation area (AA) ownership information on each node of a plurality of nodes of a cluster representing the distributed storage system relating to a respective set of one or more dynamically extensible file systems (DEFSs) of a plurality of DEFSs of the distributed storage system that are resident on the node; and
for each AA of a plurality of AAs, selectively perform, by a node-level disaggregated workflow operable on a first node of the plurality of nodes, processing relating to the AA requested by a cluster-wide workflow based on the in-memory AA ownership cache on the first node indicating the AA is owned by one of the respective set of one or more DEFSs resident on the first node.

16. The distributed storage system of claim 15, wherein selectively performing the processing relating to the AA comprises skipping the processing for the AA when the AA is not owned by a DEFS of the respective set.

17. The distributed storage system of claim 15, wherein the processing relating to the AA comprises Redundant Array of Independent (RAID) reconstruction.

18. The distributed storage system of claim 15, wherein the in-memory cache of AA ownership information includes cached DEFS AA owner metafile information containing, for a given DEFS of the respective set, at least a portion of an AA bitmap indicative of those AAs of the plurality of AAs owned by the given DEFS.

19. The distributed storage system of claim 18, wherein the instructions further cause the distributed storage system to determine whether a given AA of the plurality of AAs is owned by a DEFS by evaluating the portion of the AA bitmap corresponding to the AA for each DEFS of the respective set.

20. The distributed storage system of claim 15, wherein the in-memory cache of AA ownership information includes cached AA label information containing, for a given AA of a plurality of AAs, an AA label having (i) a current owner field containing a DEFS identifier (ID) identifying a first DEFS of the plurality of DEFSs that currently owns the given AA and (ii) a proposed owner field, which when ownership of the given AA is in transition contains a DEFS ID identifying a second DEFS of the plurality of DEFSs to which the ownership is to be transferred.

21. The distributed storage system of claim 15, wherein the instructions further cause the distributed storage system to, for each AA of the plurality of AAs, selectively perform, by a node-level disaggregated workflow operable on a second node of the plurality of nodes, the processing relating to the AA requested by the cluster-wide workflow based on the in-memory AA ownership cache on the second node indicating the AA is owned by one of the respective set of one or more DEFSs resident on the second node.
